(19) United States
(12) Patent Application Publication
(10) Pub. No.: US 2025/0199747 A1
(43) Pub. Date: Jun. 19, 2025

(54) DISPLAY APPARATUS AND PROCESSING METHOD FOR DISPLAY APPARATUS

(71) Applicant: HISENSE VISUAL TECHNOLOGY CO., LTD., Qingdao (CN)

(72) Inventors: Jingkun ZHANG, Qingdao (CN); Chenglong LIU, Qingdao (CN); Fuyun WANG, Qingdao (CN); Zhaolei LIU, Qingdao (CN); Xiujuan PANG, Qingdao (CN); Xuesheng ZHU, Qingdao (CN); Yongjiang SUN, Qingdao (CN); Yinghao HE, Qingdao (CN); Yujie DIAO, Qingdao (CN); Fang LIU, Qingdao (CN)

(21) Appl. No.: 19/071,181

(22) Filed: Mar. 5, 2025

Related U.S. Application Data
(63) Continuation of application No. PCT/CN2023/101142, filed on Jun. 19, 2023.

(30) Foreign Application Priority Data
Dec. 14, 2022 (CN) 202211610603.4
Dec. 14, 2022 (CN) 202211610610.4
Dec. 14, 2022 (CN) 202211611751.8
Dec. 14, 2022 (CN) 202211611843.6

(51) Int. Cl. G06F 3/14; G06F 9/451

(52) U.S. Cl. CPC G06F 3/1454; G06F 9/451

(57) ABSTRACT

Provided in the present application are a display apparatus and a processing method for a display apparatus. The display apparatus includes: a display, a communicating device, a memory, and at least one processor configured to execute the computer instruction to cause the display apparatus to perform the following operations: in response to a screen-mirroring cast instruction, obtaining a preparation state of a first application and starting a second application; if the preparation state is a state that supports floating, controlling the display to display the second application above the first application in a floating manner; and if the preparation state is a state that does not support floating, controlling the display to display the second application in a full-screen manner.

### CROSS REFERENCES TO RELATED APPLICATIONS

This application is a continuation of International Application No. PCT/CN2023/101142, filed on Jun. 19, 2023, which claims priorities to Chinese Patent Application No. 202211611751.8, filed on Dec. 14, 2022, Chinese Patent Application No. 202211611843.6, filed on Dec. 14, 2022, Chinese Patent Application No. 202211610603.4, filed on Dec. 14, 2022, and Chinese Patent Application No. 202211610610.4, filed on Dec. 14, 2022, all of which are hereby incorporated by reference in their entireties.

### TECHNICAL FIELD

The present application relates to the technical field of display apparatuses, and in particular to a display apparatus and a processing method for the display apparatus.

### BACKGROUND

When using a display apparatus to play applications such as videos, usually, only one application is played and displayed on the current interface. However, in some cases, users may have a need to play two or more applications on the current interface, that is, the need for applications to play on the same screen.

For example, when a user wants to watch two applications at the same time, the lower application can be played in full screen and the upper application can be floated above the lower application. Therefore, in order to achieve the purpose of playing two or more applications on the same screen, in some display apparatuses, the application interface can be floated through the native interface.

However, in the process of implementing the same screen display of applications through native interfaces, if the native interface is used to achieve floating, when different application interfaces are displayed separately on the upper application and the lower application, the application interface cannot be controlled by the remote controller or other buttons, and the upper application and the lower application cannot communicate. Therefore, the use of native interfaces results in greater interactivity and limitations in applications. Moreover, the solution of implementing the floating of the application interface in this way relies on the native interface. When the application version changes, the underlying code needs to be modified. For example, a system upgrade can be required under normal circumstances. Therefore, the application maintenance cost is also high.

### SUMMARY

A display apparatus according to embodiments of the present application can include: a display, configured to display a user interface and/or screen-mirroring cast data; a communicating device, configured to communicate with an external device and/or form a screen-mirroring cast connection with a terminal device according to a communication protocol; a memory, configured to store computer instructions and/or data associated with the display apparatus; at least one processor, in connection with the display, the communicating device and the memory, where the at least one processor can be configured to execute the computer instructions to cause the display apparatus to perform:
in response to a screen-mirroring cast instruction, obtaining a preparation state of a first application and starting a second application; where the first application is an application displayed in a current user interface, and the second application is a screen-mirroring cast application; the preparation state can be used to indicate whether the first application supports floating display;
based on that the preparation state is a state that supports floating, controlling the display to display the second application above the first application in a floating manner;
based on that the preparation state is a state that does not support floating, controlling the display to display the second application in a full-screen manner.

According to embodiments of the present application, a processing method for a display apparatus can include:
in response to a screen-mirroring cast instruction, obtaining a preparation state of a first application and starting a second application; where the first application is an application displayed in a current user interface, and the second application is a screen-mirroring cast application; the preparation state can be used to indicate whether the first application supports floating display;
based on that the preparation state is a state that supports floating, controlling the display to display the second application above the first application in a floating manner;
based on that the preparation state is a state that does not support floating, controlling the display to display the second application in a full-screen manner.

### BRIEF DESCRIPTION OF FIGURES

FIG. 1 is a schematic diagram of an operation scenario between the display apparatus and the control devices according to some embodiments of the present application.

FIG. 2 is a hardware configuration block diagram of the display apparatus in FIG. 1 according to some embodiments of the present application.

FIG. 3 is a hardware configuration block diagram of the control device in FIG. 1 according to some embodiments of the present application.

FIG. 4 is a schematic diagram of software configuration of the display apparatus in FIG. 1 according to some embodiments of the present application.

FIG. 5 is a schematic diagram of an icon control interface of a display apparatus application according to some embodiments of the present application.

FIG. 6 is a schematic flow diagram of a processing method for a display apparatus according to some embodiments of the present application.

FIG. 7 is a schematic diagram of a process of establishing a first application and a second application according to some embodiments of the present application.

FIG. 8 is a schematic diagram of an operation prompt interface displayed above a first application according to some embodiments of the present application.

FIG. 9 is a schematic diagram of a process of floating a second application above a first application according to some embodiments of the present application.

FIG. 10 is a schematic diagram showing the effect of floating a second application above a first application according to some embodiments of the present application.

FIG. 11 is a schematic diagram of a focus instruction flow process according to some embodiments of the present application.

FIG. 12 is a schematic diagram of a process of exiting a second application according to a disconnection instruction according to some embodiments of the present application.

FIG. 13 is a schematic diagram of parsing a disconnection reason according to a disconnection instruction according to some embodiments of the present application.

FIG. 14 is a schematic diagram of a display apparatus displaying a prompt interface according to some embodiments of the present application.

FIG. 15 is a schematic diagram of a process of playing media data according to a screen switching instruction according to some embodiments of the present application.

FIG. 16 is a schematic diagram of a second application displayed in a horizontal state according to some embodiments of the present application.

FIG. 17 is a schematic diagram of a second application displayed in a vertical state according to some embodiments of the present application.

FIG. 18 is a schematic diagram of another processing method for a display apparatus according to some embodiments of the present application.

FIG. 19 is a schematic diagram showing the effect of an initial user interface in which applications are displayed on the same screen according to some embodiments of the present application.

FIG. 20 is a schematic diagram of an effect of displaying an operation prompt interface according to some embodiments of the present application.

FIG. 21 is a schematic diagram showing the effect of displaying another operation prompt interface according to some embodiments of the present application.

FIG. 22 is a schematic diagram of a process of establishing data intercommunication between a first application and a second application according to some embodiments of the present application.

FIG. 23 is a schematic diagram showing the effect of displaying applications on the same screen according to some embodiments of the present application.

FIG. 24 is a schematic diagram showing the effect of applications being displayed on the same screen after switching according to some embodiments of the present application.

FIG. 25 is a schematic diagram showing the effect of closing a lower layer application according to some embodiments of the present application.

FIG. 26 is a schematic diagram showing the effect of the close reason prompt information according to some embodiments of the present application.

FIG. 27 is a schematic diagram of the structure of a display apparatus according to some embodiments of the present application.

FIG. 28 is a rear view diagram of a display apparatus according to some embodiments of the present application.

FIG. 29 is a flowchart diagram of a third processing method for a display apparatus according to some embodiments of the present application.

FIG. 30 is a schematic diagram showing the effect of a display in a horizontal state according to some embodiments of the present application.

FIG. 31 is a schematic diagram showing the effect of a display in a vertical state according to some embodiments of the present application.

FIG. 32 is a schematic diagram showing the effect of starting a first application in a horizontal state according to some embodiments of the present application.

FIG. 33 is a schematic diagram showing the effect of displaying applications on the same screen in a horizontal state according to some embodiments of the present application.

FIG. 34 is a schematic diagram showing the effect of displaying a second application in full screen in a horizontal state according to some embodiments of the present application.

FIG. 35 is a schematic diagram showing the effect of displaying an operation prompt interface in a horizontal state according to some embodiments of the present application.

FIG. 36 is a schematic diagram showing the effect of displaying another operation prompt interface in a horizontal state according to some embodiments of the present application.

FIG. 37 is a schematic diagram showing the effect of displaying an operation prompt interface in a vertical state according to some embodiments of the present application.

FIG. 38 is a schematic diagram of a process of establishing data intercommunication between a first application and a second application according to some embodiments of the present application.

FIG. 39 is a schematic diagram showing the effect of switching to a vertical state and displaying applications on the same screen according to some embodiments of the present application.

FIG. 40 is a schematic diagram showing the effect of switching to a vertical state in which the first application does not support the vertical screen direction according to some embodiments of the present application.

FIG. 41 is a schematic structural diagram of a display apparatus according to some embodiments of the present application.

FIG. 42 is a first schematic diagram of a terminal device displaying a screen-mirroring settings interface according to some embodiments of the present application.

FIG. 43 is a second schematic diagram of a terminal device displaying a screen-mirroring settings interface according to some embodiments of the present application.

FIG. 44 is a schematic diagram of a display apparatus displaying a screen-mirroring request interface according to some embodiments of the present application.

FIG. 45 is a schematic diagram of display interfaces of a display apparatus and a terminal device after a screen-mirroring cast connection is successful according to some embodiments of the present application.

FIG. 46 is a schematic diagram of a terminal device displaying a first screen-mirroring interface according to some embodiments of the present application.

FIG. 47 is a schematic diagram of a terminal device displaying a screen recording setting interface according to some embodiments of the present application.

FIG. 48 is a schematic diagram of a display apparatus dynamically adjusting image quality parameters according to some embodiments of the present application.

FIG. 49 is a first flowchart diagram of a fourth processing method for a display apparatus according to some embodiments of the present application.

FIG. 50 is a second flowchart diagram of the fourth processing method for a display apparatus according to some embodiments of the present application.

### DETAILED DESCRIPTION

In order to make the purpose, technical solutions and advantages of embodiments of the present disclosure clearer, the technical solutions in the embodiments of the present disclosure will be clearly and completely described below in conjunction with the specific embodiments of the present application and the drawings in the embodiments of the present disclosure. Obviously, the described embodiments are part of the embodiments of the present disclosure, rather than all of the embodiments.

It should be noted that the brief description of terms in some embodiments of the present application is only for the convenience of understanding the implementation methods described below, and is not intended to limit the implementation methods of some embodiments of the present application. Unless otherwise indicated, these terms should be understood according to their ordinary and customary meanings.

The terms “comprise” and “include” and any variations thereof, are intended to cover but not exclude inclusion, for example, a product or device including a list of components is not necessarily limited to all the components expressly listed but may include other components not expressly listed or inherent to such product or device.

The term “module” refers to any known or later developed hardware, software, firmware, artificial intelligence, fuzzy logic, or combination of hardware and/or software code that is capable of performing the functions associated with that element.

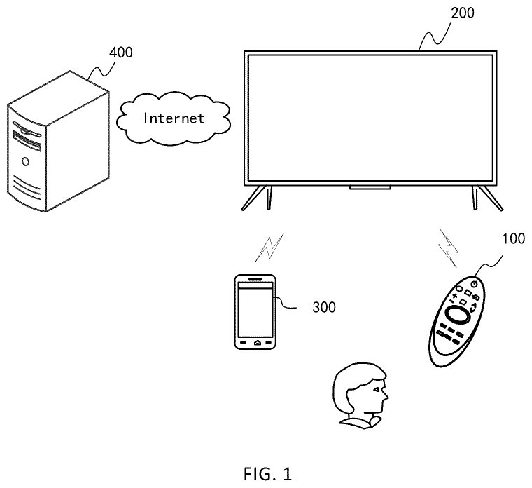

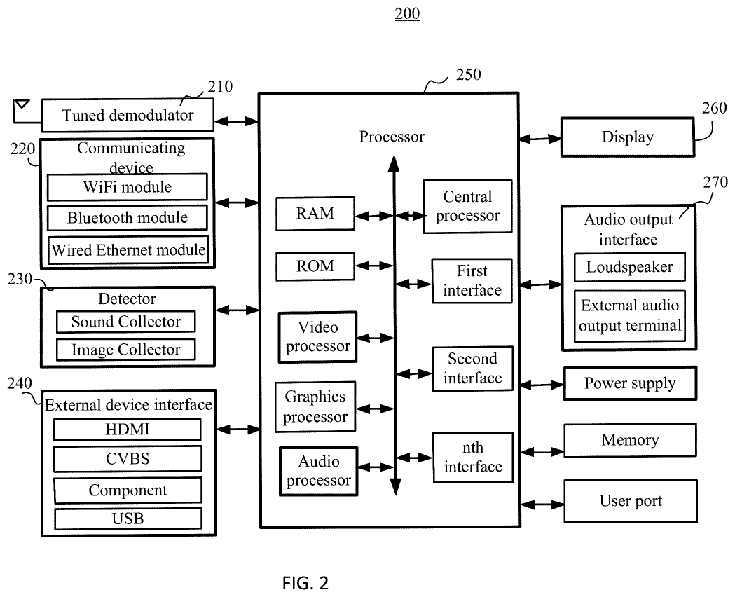

The display apparatus provided in the embodiments of the present application can have various implementation forms, for example, it can be a television, a smart television, a laser screen-mirroring device, a monitor, an electronic bulletin board, an electronic table, etc. FIG. 1 and FIG. 2 are a specific implementation of the display apparatus of the present application.

FIG. 1 is a schematic diagram of an operation scenario between a display apparatus and the control devices according to some embodiments of the present application. As shown in FIG. 1, a user can operate a display apparatus 200 through a terminal device 300 and a control device 100.

In some embodiments, the control device 100 can be a remote controller, and the communication between the remote controller and the display apparatus can include infrared protocol communication or Bluetooth protocol communication, and other short-range communication methods, to control the display apparatus 200 via a wired or wireless manner. The user can control the display apparatus 200 by inputting user instructions through buttons on the remote controller, voice input, control panel input, etc. Alternatively, the control device 100 may also be a mouse, and the mouse and the display apparatus can be connected via a wired or wireless manner.

In some embodiments, the terminal device 300 can install software applications with the display apparatus 200, and can realize connection communication through a network communication protocol to achieve the purpose of one-to-one control operation and data communication. The audio and video content displayed on the terminal device 300 can also be transmitted to the display apparatus 200 to achieve a synchronous display function. The terminal device 300 can be a mobile terminal, a tablet computer, a computer, a laptop computer, a tablet computer, a smart screen, etc.

In some embodiments, the display apparatus cannot use the above-mentioned terminal device or control device to receive instructions, but can receive user control through touch or gestures.

In some embodiments, the display apparatus 200 can also be controlled in manners other than the control device 100 and the terminal device 300. For example, the user's voice instruction control can be directly received through a module for obtaining voice instructions configured inside the display apparatus 200, or the user's voice instruction control can be received through a voice control device set outside the display apparatus 200.

As also shown in FIG. 1, the display apparatus 200 can also perform data communication with the server 400 through various communication methods. The display apparatus 200 can be allowed to be communicatively connected via a local area network (LAN), a wireless local area network (WLAN), and other networks. The server 400 can provide various contents and interactions to the display apparatus 200.

In addition to providing a display reception television function, the display apparatus 200 can also provide a network television function, including but not limited to network television, smart television, Internet Protocol television (IPTV), and the like.

FIG. 2 is a hardware configuration block diagram of the display apparatus 200 in FIG. 1 according to some embodiments of the present application. The display apparatus 200 can include at least one of a tuner and demodulator 210, a communicating device 220, a detector 230, an external device interface 240, at least one processor 250, a display 260, an audio output interface 270, a memory, a power supply, and a user interface.

In some embodiments, the detector 230 can be used to collect signals from the external environment or from interaction with the external environment. For example, the detector 230 can include a light receiver, a sensor for collecting ambient light intensity; or, the detector 230 can include an image collector, such as a camera, which can be used to collect external environmental scenes, user attributes or user interaction gestures; or, the detector 230 can include a sound collector, such as a microphone, for receiving external sounds.

In some embodiments, the display 260 can include a display screen component for presenting images, and a driving component for driving image display, which can be used to receive image signals output from at least one processor, display video content, image content, and a menu control interface component and a user interface (UI), etc. The display 260 can be a liquid crystal display, an OLED display, or a screen-mirroring display, and can also be a screen-mirroring device and a screen-mirroring screen.

In some embodiments, the communicating device 220 is a component for communicating with an external device or a server 400 according to various communication protocol types. For example, the communicating device 220 can include at least one of a Wifi module, a Bluetooth module, a wired Ethernet module, an RF (radio frequency) module, and other network communication protocol chips or near field communication protocol chips, and an infrared receiver. The display apparatus 200 can establish transmission and reception of control signals and data signals with the control device 100 or the server 400 through the communicating device 220.

In some embodiments, at least one processor 250 can control the operation of the display apparatus and responds to user operations through various software control programs stored in the memory. At least one processor 250 can control the overall operation of the display apparatus 200. For example, in response to receiving a user instruction for selecting a UI object to be displayed on the display 260, the at least one processor 250 can perform an operation related to the object selected by the user instruction.

In some embodiments, at least one processor 250 can include at least one of: a central processing unit (CPU), a video processor, an audio processor, a graphics processing unit (GPU), a random access memory (RAM), a read-only memory (ROM), a first interface to an nth interface for input/output, a communication bus (Bus), etc.

In some embodiments, the user can input a user instruction through a graphical user interface (GUI) displayed on the display 260, and the user input interface can receive the user input instruction through the graphical user interface (GUI).

In some embodiments, the external device interface 240 can include but is not limited to the following: any one or more interfaces such as high-definition multimedia interface (HDMI), analog or digital high-definition component input interface (component), composite video input interface (CVBS), USB input interface (USB), RGB terminal, etc. It can also be a composite input/output interface formed by the above-mentioned multiple interfaces.

In some embodiments, the tuner-demodulator 210 can receive display television signals via wired or wireless reception, and demodulate audio and video signals, such as EPG data signals, from a plurality of wireless or wired display television signals.

In some embodiments, at least one processor 250 and the tuner-demodulator 210 can be located in different separate devices, that is, the tuner-demodulator 210 can also be in an external device of the main device where the at least one processor 250 is located, such as an external set-top box.

In some embodiments, a user interface can be an interface that can be used to receive control input.

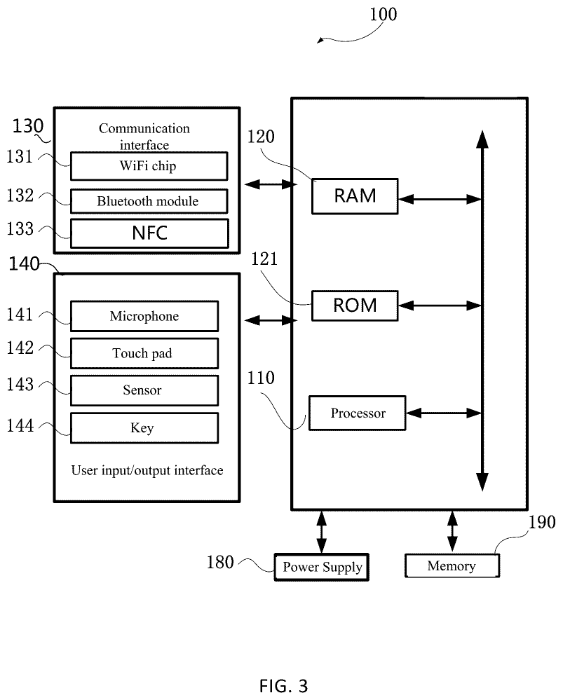

FIG. 3 is a hardware configuration block diagram of the control device in FIG. 1 according to some embodiments of the present application. As shown in FIG. 3, the control device 100 can include at least one processor 110, a communication interface 130, a user input/output interface 140, a memory 190, and a power supply 180.

The control device 100 can be configured to control the display apparatus 200, and can receive user input operation instructions, and convert the operation instructions into instructions that the display apparatus 200 can recognize and respond to, playing the role of an interactive intermediary between the user and the display apparatus 200.

The control device 100 can further include a RAM 120, a ROM 121, and a communication bus. At least one processor 110 can be used to control the operation and operation of the control device 100, as well as the communication and cooperation between internal components and external and internal data processing functions.

Under the control of the at least one processor 110, the communication interface 130 can implement communication of control signals and data signals with the display apparatus 200. The communication interface 130 can include at least one of a WiFi chip 131, a Bluetooth module 132, and an NFC module 133 and other near field communication modules.

The input interface of the user input/output interface 140 can include at least one of a microphone 141, a touch panel 142, a sensor 143, and a button 144 and other input interfaces.

In some embodiments, the control device 100 can include at least one of a communication interface 130 and a user input/output interface 140. The control device 100 can be configured with a communication interface 130, such as a Wifi, Bluetooth, NFC or other module, which can encode the user input instruction through the WiFi protocol, Bluetooth protocol, or NFC protocol and send it to the display apparatus 200.

The memory 190 can be used to store various operating programs, data and applications for driving and controlling the control device 100 under the control of at least one processor. The memory 190 can store various control signal instructions input by the user.

The power supply 180 can be used to provide operating power support for various components of the control device 100 under the control of at least one processor.

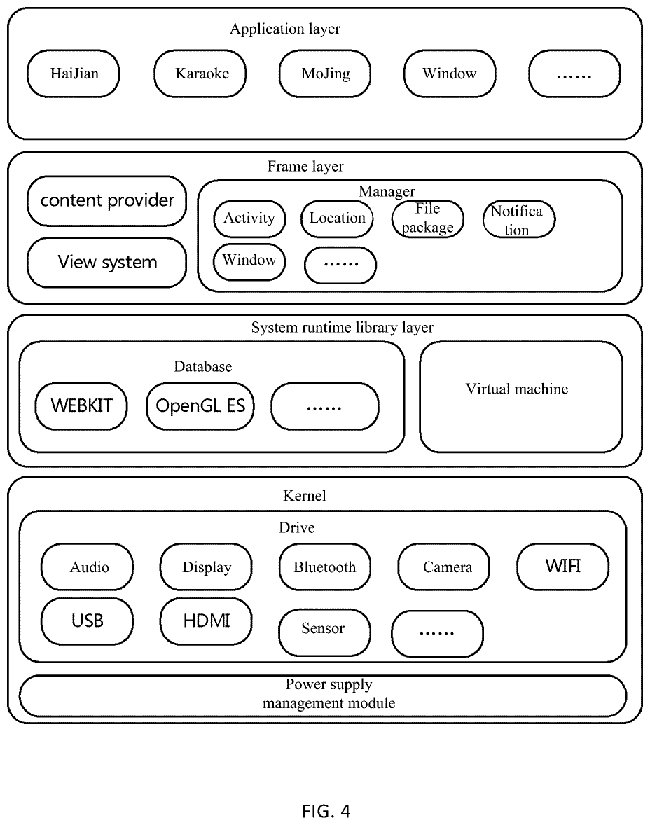

FIG. 4 is a schematic diagram of the software configuration in the display apparatus in FIG. 1 according to some embodiments of the present application. In some embodiments, the system is divided into four layers, from top to bottom, namely, the application (Applications) layer (referred to as “application layer”), the application framework (Application Framework) layer (referred to as “framework layer”) and the system library layer (referred to as “system runtime library layer”), and the kernel layer.

In some embodiments, at least one application can be running in the application layer. These applications can be window programs, system settings programs, clock programs, camera applications, etc. that come with the operating system; or they can be applications developed by third-party developers.

The framework layer can provide application programming interface (API) and programming framework for applications in the application layer. The application framework layer can include some predefined functions. The application framework layer can be equivalent to a processing center, which can determine the actions to be taken by the applications in the application layer.

As shown in FIG. 4, in some embodiments of the present application, the application framework layer can include managers, content providers, and a view system, etc.

In some embodiments, the activity manager can be used to manage the life cycle of each application and the general navigation back function.

In some embodiments, a window manager can be used to manage all window programs.

In some embodiments, the system runtime library layer can provide support for the upper layer, namely the framework layer. When the framework layer is accessed, the operating system will run the C/C++ library contained in the system runtime library layer to implement the functions to be implemented by the framework layer.

In some embodiments, the kernel layer can be a layer between hardware and software. As shown in FIG. 4, the kernel layer can include at least one of the following drivers: audio driver, display driver, Bluetooth driver, camera driver, WIFI driver, USB driver, HDMI driver, sensor driver (such as fingerprint sensor, temperature sensor, touch sensor, pressure sensor, etc.), etc.

In some embodiments, the kernel layer can further include a power driver module for performing power management.

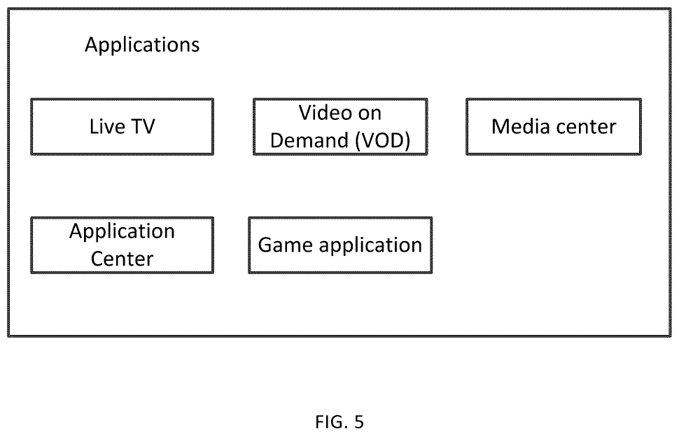

As shown in FIG. 5, the application layer of the display apparatus 200 can include at least one application that can display a corresponding icon control in the display, such as: a live TV application icon control, a video on demand application icon control, a media center application icon control, an application center icon control, a game application icon control, etc.

Based on the above display apparatus 200, media data such as videos can be played. When using the display apparatus 200 to play applications such as videos, usually, the current interface can only play and display one application. However, in some cases, the user can need to play two or more applications on the current interface, that is, the applications can need to be played on the same screen.

In some embodiments, when a user wants to watch two applications at the same time, the lower application can be played in full screen, and the upper application can be floated above the lower application. Therefore, in order to achieve the purpose of playing two or more applications on the same screen, in some display apparatuses, the application interface can be floated through the native interface.

Take the scenario where users use display apparatuses to assist in fitness as an example. When the users are exercising through a display apparatus, they want to display both the camera preview screen, that is, the user's own fitness action screen, and the screen-mirroring screen or fitness video screen in the same window, that is, they want to achieve the purpose of learning and practicing in the same window. For this scenario, the screen-mirroring SDK (Software Development Kit) can be integrated into the fitness application in the display apparatus. After the display apparatus receives the screen-mirroring cast instruction, the lower-level fitness application can display the user's fitness preview screen, and the upper-level application can be displayed floating above the lower-level application, thus achieving the purpose of displaying two applications in the same window. In some embodiments of the present application, the fitness application can be understood as a related application that supports users to display fitness images, and can be combined with the camera of the display apparatus 200. The user can stand in front of the display apparatus 200, the camera can capture the user's movements, and the user's fitness images can be displayed through the fitness application.

However, integrating the SDKs of multiple applications into the same application will cause the applications that integrate multiple SDKs to have problems such as poor interactivity and scalability during the maintenance process. That is, when the screen-mirroring cast application transmits data or connection to the fitness application, the fitness application needs to start playing its own interface after receiving it. When the screen-mirroring cast application needs to be switched to full screen or non-full screen, the code and design of the related applications can need to be rewritten, and the maintenance and upgrade costs are high. For example, if a third-party application wants to play in the same window, the third-party application can also need to be integrated, and the scalability is poor, which will affect the operating efficiency of the display apparatus and the user experience.

In addition, in the above process of realizing the same-screen display of applications through the native interface, when the upper application and the lower application display different application interfaces respectively, the application interface cannot be controlled by the remote controller or other buttons, and the upper application and the lower application cannot communicate. Therefore, the use of native interfaces can result in greater interactivity and limitations in applications. Moreover, the solution of implementing the floating of the application interface in this way relies on the native interface. When the application version changes, the underlying code can need to be modified. For example, a system upgrade can be required under normal circumstances. Therefore, the application maintenance cost is also high.

In order to solve the problems of application interactivity, large limitations and high maintenance costs during the same-screen display of applications, some embodiments of the present application can provide a processing method for a display apparatus. In some embodiments, the display apparatus 200 can include a display 260, which can be configured to display a user interface and/or screen-mirroring cast data; a communicating device 220, which can be configured to communicate with an external device and/or be connected with a terminal device for screen-mirroring according to a communication protocol; a memory, which can be configured to store computer instructions and/or data associated with the display apparatus; at least one processor 250, which can be connected with the display 260, the communicating device 220 and the memory, and can be configured to execute the computer instructions to cause the display apparatus 200 to perform: in response to a screen-mirroring cast instruction, obtaining a preparation state of a first application and starting a second application; where the first application can be an application displayed in a current user interface, and the second application can be a screen-mirroring cast application; the preparation state can be used to indicate whether the first application supports floating display; based on that the preparation state is a state that supports floating, controlling the display to display the second application above the first application in a floating manner; based on that the preparation state is a state that does not support floating, controlling the display to display the second application in a full-screen manner. The present application aims to determine whether to floating display the upper layer application above the lower layer application by judging the preparation state of the lower layer application, thereby establishing interaction between the upper layer application and the lower layer application. Because the lower application is floated by the upper application and cannot capture the focus, the upper application captures the focus instruction and sends it to the lower application, and then the lower application can send the focus instruction to other applications. Other applications can perform corresponding operations according to the focus instructions.

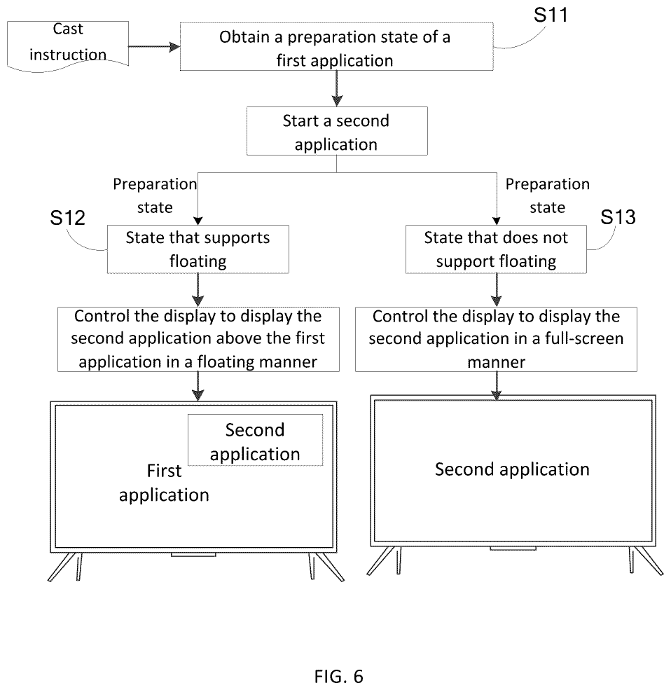

In order to facilitate the understanding of the technical solutions in some embodiments of the present application, each step can be described in detail below in conjunction with some specific embodiments and drawings. FIG. 6 is a flow chart of a processing method for a display apparatus according to some embodiments of the present application. As shown in FIG. 6, a processing method for a display apparatus can include the following steps S11 to S13.

S11: in response to a screen-mirroring cast instruction, obtain a preparation state of a first application and start a second application.

In some embodiments, the screen-mirroring cast instruction can be issued through a terminal device such as a mobile phone, or issued by a remote controller matching the display apparatus 200, or issued in other forms, which is not limited in this application. It can be understood that a screen-mirroring cast connection can be established through the screen-mirroring cast instruction, so that the screen-mirroring cast application can be displayed through the screen-mirroring cast instruction.

In some embodiments, the user can issue a screen-mirroring cast instruction through the terminal device 300 and send the screen-mirroring cast instruction to the display apparatus 200 through the WiFi network. The display apparatus 200 then can complete the transmission protocol configuration according to the screen-mirroring cast instruction, thereby establishing a transmission channel for the screen-mirroring cast data with the terminal device 300. For example, for system applications or direct screen-mirroring at the system level, the terminal device 300 can use Miracast screen-mirroring, Airplay screen-mirroring or WiFi screen-mirroring protocol to establish a transmission channel for screen-mirroring cast data with the display apparatus 200. The display apparatus 200 can receive the screen-mirroring cast data of the terminal device 300 through the transmission channel, that is, the user interface applied in the terminal device 300 can be displayed on the display 260.

In some embodiments, the display apparatus 200 can also realize screen-mirroring cast connection with the terminal device 300 through different connection methods. For example, when the display apparatus 200 and the terminal device 300 are connected with the same wireless local area network, a screen-mirroring cast connection can be established based on the WiFi network. For another example, when both the display apparatus 200 and the terminal device 300 are provided with NFC (Near Field Communication) components, a screen-mirroring cast connection relationship can be established through the NFC components. Obviously, other wired or wireless connection methods can also be used between the display apparatus 200 and the terminal device 300 to establish a screen-mirroring cast connection relationship, such as RF radio frequency connection, infrared connection, cellular network, etc.

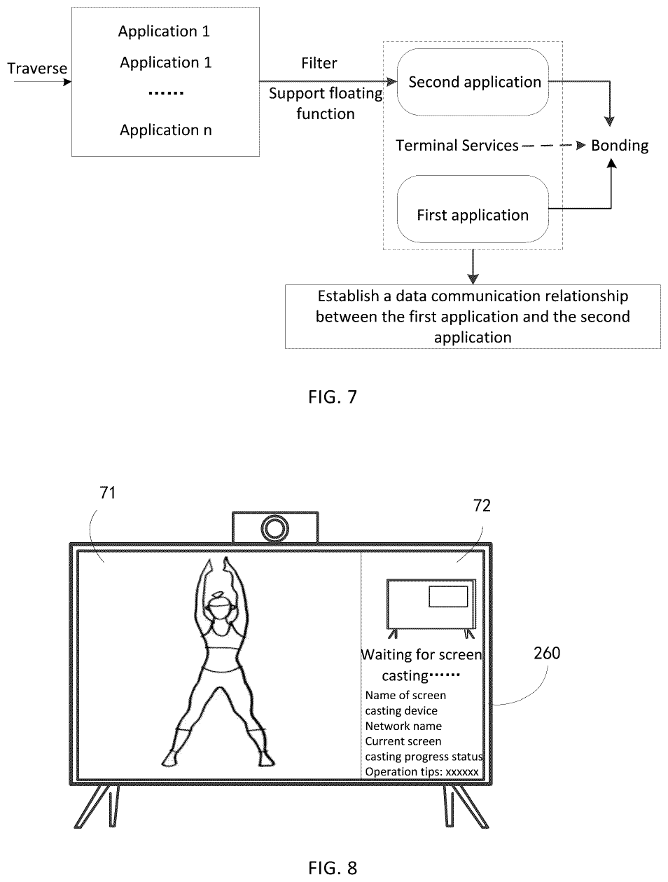

In order to establish interaction between the upper layer application and the lower layer application, in some embodiments, the display apparatus 200 can be implemented in the following manner. FIG. 7 is a flowchart of establishing a first application and a second application according to some embodiments of the present application. As shown in FIG. 7, the display apparatus 200 can traverse all deployed applications and selects a second application that supports the floating function from all applications. It is understandable that the second application can be one or more. When there is one second application, two applications can be displayed simultaneously in the same window. When there are multiple second applications, multiple applications can be displayed simultaneously in the same window. After the second application supporting the floating function is screened out, the client service in the first application and the client service in the second application can be bonded, so that a data intercommunication relationship between the first application and the second application can be established.

It should be noted that when establishing the data intercommunication relationship between the first application and the second application, the client services of other applications can be bonded after the first application starts the camera. In this way, after bonding operation, the first application can send messages to other applications, for example, the first application can send messages to the second application, and the first application can send the preparation state of whether the first application supports the floating application. After receiving the message sent by the first application, other applications can use this as a basis to execute subsequent processes.

In some embodiments, the first application can be an application displayed in the current user interface, such as a lower layer application, and the second application can be a screen-mirroring cast application, such as an upper-layer application displayed in floating. The preparation state can be used to indicate whether the first application supports floating display. The preparation state in the first application can include multiple states such as preparing, preparation completed, preparation abnormality, etc., which are not limited in this application. After the second application is started, the first application can send its preparation state to the second application, so that the second application can determine whether to be displayed in a floating manner above the first application.

In some embodiments, all applications on the current device can be traversed through metadata information to determine whether there is a second application that supports floating. If a second application supporting the floating function is screened out, the preset client services can be bonded in sequence, so that the first application and the second application complete the interaction.

In some embodiments, the state of the first application can be represented by different identifiers. The identifier of the first application and the content it represents can include: IDLE-preparing, PREPARE-preparation completed, FOCUS-preparation completed, FINISH-interface exit, ERROR-abnormal. It should be noted that the above identifiers are only for illustrative purposes and do not constitute a limitation on the content of the identifier. After obtaining the preparation state of the first application, based on the interactive function between the first application and the second application, the first application can send the preparation state to the second application so that the second application can determine whether to perform floating display. After step S11 is completed, the following step S12 can be performed.

S12: based on that the preparation state is a state that supports floating, control the display to display the second application above the first application in a floating manner.

In some embodiments, after receiving the preparation state sent by the first application, the second application can determine whether it supports the floating state according to the specific situation of the preparation state. When the preparation state of the first application is preparation completed or FOCUS preparation completed, it can represent that the first application supports floating. At this time, the display apparatus 200 can control the display 260 to display the second application in a floating manner above the first application.

It should be noted that the identifier of the preparation state can be different for different applications. In some embodiments, the display apparatus 200 can also set a corresponding identifier to indicate the preparation completed state of the first application according to the type of the first application. For example, some self-developed screen-mirroring cast applications that rely on wireless network communication technology are background service applications. Since background service applications themselves can be configured with background running and floating functions, the PREPARED state represents a preparation state that supports floating. For non-background service applications, for example, some offline screen-mirroring that relies on the startup interface can only be used on a certain interface. The application can control its function switch through FOCUS to notify the current application that it can support floating interface display.

In some embodiments, before the second application is displayed floating above the first application, the display apparatus 200 can control the display 260 to display an operation prompt interface above the first application to provide operation prompts for the user to operate the screen-mirroring and guide the user on how to implement the screen-mirroring operation.

FIG. 8 is a schematic diagram of the operation prompt interface displayed above the first application according to some embodiments of the present application. As shown in FIG. 8, the user image captured by the camera can be displayed in interface 71, and the name of the screen-mirroring device, the network name, the current screen-mirroring progress state, operation prompts, etc. will be displayed in interface 72, i.e., the operation prompt interface. In this way, the user can operate according to the operation prompts on the one hand, and on the other hand, the display apparatus 200 can feedback the current state of the screen-mirroring cast connection on the display 260.

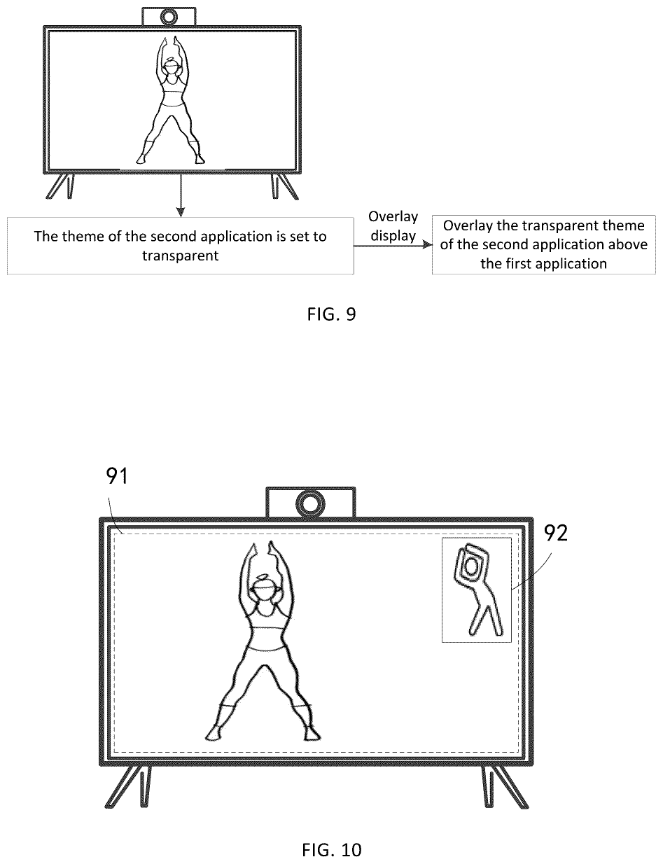

FIG. 9 is a schematic diagram of a process of floating a second application above a first application according to some embodiments of the present application. As shown in FIG. 9, in some embodiments, floating the second application above the first application can be performed in the following manner. Firstly, the display apparatus 200 can control the display 260 to display the first application in full screen, then can set the theme of the second application to be transparent, and finally can control the display 260 to overlay and display the second application with a transparent theme above the first application.

FIG. 10 is a schematic diagram of the effect of floating a second application above a first application according to some embodiments of the present application. As shown in FIG. 10, taking the first application as a fitness application as an example, when the second application is displayed floating above the first application, the fitness application can first be displayed in full screen on the interface 91. After receiving the screen-mirroring cast instruction, the display apparatus 200 can determine the current preparation state of the fitness application. If the preparation state of the first application is a preparation completed state or a focus preparation completed state, it means that the first application supports the floating state. That is to say, in embodiments of the present application, when performing a floating display operation, the second application in the floating display can judge the preparation state of the first application in the lower layer, and only when the lower layer application can support floating display, the second application can be displayed in the floating state above the first application in the lower layer.

In some embodiments, when a second application is displayed floating above a first application, the theme of the second application can be set to transparent. In this way, the second application can be displayed in the same window as the first application, and the second application cannot completely block the first application while being displayed floating above the first application, thereby realizing the function of displaying the second application floating above the first application. It should be noted that during the screen-mirroring cast application process, one application can be displayed floating above the first application, or multiple applications can be displayed floating, and the present application does not make any specific limitations on this.

Still taking the first application as the fitness applications as an example, the interface 91 in the fitness application displays the camera preview screen, that is, the user's fitness screen. When the second application is displayed floating above the first application, the position of the floating display can be pre-set. For example, it can be displayed floating in the upper right corner, or it can be displayed floating in the upper left corner, etc. Taking the floating display of the second application in the upper right corner as an example, assuming that the second application is a screen-mirroring fitness video image, its top upper right corner interface 92 can be the fitness video screen, and the floating interface outside the image is transparent. In this way, only part of the fitness video image blocks the first application, the purpose of which is to learn and practice at the same time. Users can still see the other part of the fitness application interface, which cannot affect the user's viewing of their own fitness images, thereby achieving the purpose of displaying two applications in the same window at the same time.

In some embodiments, in combination with the operation prompt interface of FIG. 8, when the first application supports floating display of the second application, a floating display operation of the second application can be performed. At the same time, after the second application is displayed in a floating state above the first application, the underlying fitness application can be notified that the floating operation has been started by sending a message or the like, and a floating receipt is generated and sent to the first application. In embodiments of the present application, the floating receipt can be understood as the receipt information that the second application has successfully achieved the floating display state. In this way, after receiving the floating receipt, the first application can exit the operation prompt interface according to the floating receipt. At this time, the operation prompt interface in FIG. 8 can disappear, and only the second application is displayed in floating above the fitness application.

The floating receipt sent by the second application to the first application can be state information, for example, it can be a connected state and a disconnected state. If the second application in the upper layer sends a connected state to the first application in the lower layer, it means that the floating display of the first application and the second application has been successful, and the operation prompt interface in FIG. 8 can disappear. On the contrary, if the second application sends a disconnected state to the first application, it means that the floating display of the two is unsuccessful. In this case, the operation prompt interface in FIG. 8 can be retained to allow the user to perform the floating display operation again based on it. After step S12 is completed, the following step S13 can be executed.

S13: based on that the preparation state is a state that does not support floating, control the display to display the second application in a full-screen manner.

In some embodiments, after the second application receives the preparation state sent by the first application, the second application can determine whether the first application can support the floating state through the preparation state. If the preparation state is a state that does not support the floating state, the display apparatus 200 can control the display 260 to display the second application in full screen.

The state that does not support floating can be the FINISH interface exit or the ERROR abnormal state, that is, the first application can have an abnormal situation. For example, the camera of display apparatus 200 can have an abnormality, or the first application interface can have an abnormality, etc. In this scenario, after receiving the screen-mirroring cast instruction, the display apparatus 200 can control display 260 to display the second application in full screen, that is, to display the screen-mirroring interface in full screen, so that the user can complete fitness exercises according to the second application.

It should be noted that in embodiments of the present application, when two applications are displayed simultaneously in the same window, that is, when two application screens are displayed on the same screen, since the two applications are independent of each other and the SDKs of the two applications are not integrated into the same application, the first application and the second application do not rely on the native interface, the application has stronger scalability, better operability, and is easier to maintain, reducing maintenance costs. In addition, since interactive communication can be established between the two applications, the two applications can interact with each other while being displayed in superimposed form. The two applications can communicate with each other and perform related operations as needed, thus solving the problems of application interactivity, large limitations, and high maintenance costs during the same-screen display of applications.

It can be seen from the above technical solution that the above embodiments provide a processing method for a display apparatus that responds to a screen-mirroring cast instruction, the preparation state of the first application can be obtained, and the second application can be started; if the preparation state is a state that supports floating, the display can be controlled to display the second application in a floating state above the first application; if the preparation state is a state that does not support floating, the display can be controlled to display the second application in full screen. When two applications are displayed simultaneously in the same window in embodiments of the present application, since the two applications are independent of each other and are not integrated into the same application, the first application and the second application do not rely on native interfaces, and the applications are more expandable, more operable, easier to maintain, and have reduced maintenance costs. In addition, since interactive communication can be established between the two applications, they can also interact with each other while being displayed in superimposition. The two applications can communicate with each other and perform related operations as needed, thereby solving the problems of application interactivity, large limitations, and high maintenance costs during the same-screen display of applications.

In some embodiments, after the second application is displayed floating above the first application, the first application at the lower layer cannot capture the focus instruction because the first application is blocked by the second application. The focus instruction can be an instruction issued by a remote controller matching the display apparatus 200. In this way, the remote controller cannot be able to control the operation of the first application, and the first application cannot be able to capture the focus instruction issued by the remote controller.

In order to ensure that the first application in the lower layer can also obtain the focus instruction, the display apparatus 200 can further perform the following operations. FIG. 11 is a schematic diagram of the focus instruction flow according to some embodiments of the present application. As shown in FIG. 11, in some embodiments, the display apparatus 200 can control the second application to capture the focus instruction in the user interface, and then the second application can send the captured focus instruction to the first application. After receiving the focus instruction, the first application can parse the focus instruction and generate a parsing result. At the same time, the parsing result of the focus instruction is sent to other applications so that the other applications perform related operations according to the parsing result, where the other applications are applications in the display apparatus other than the first application and the second application.

After the focus instruction is issued through the remote controller, the second application can capture the focus instruction because it is displayed floating above the first application, while the first application in the lower layer cannot capture the focus instruction, and the remote controller cannot control the first application in the lower layer.

In order to allow the first application to also obtain the focus instruction, in some embodiments, after the second application captures the focus instruction, the focus instruction can be sent to the first application based on the data intercommunication relationship established between the first application and the second application. After receiving the focus instruction, the first application can parse the focus instruction and generate a parsing result. The focus instruction can be to adjust the contrast of the current image. When the second application captures the focus instruction, the instruction for adjusting the image contrast can be sent to the first application. After receiving the instruction, the first application can notify other applications except the first application and the second application of the instruction, so that all applications can obtain the focus instruction issued by the remote controller and can perform corresponding operations according to the specific content of the instruction.

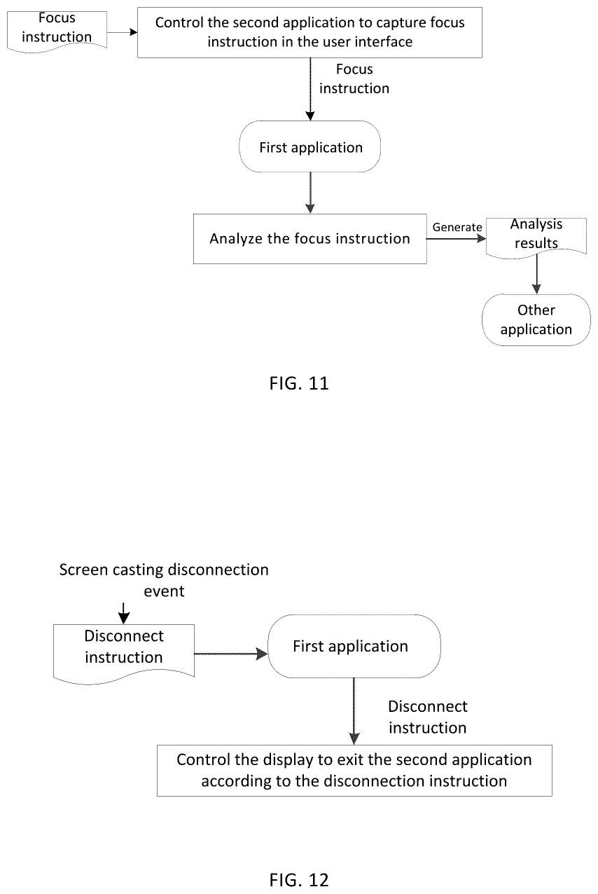

FIG. 12 is a schematic diagram of the process of exiting the second application according to the disconnection instruction according to some embodiments of the present application. As shown in FIG. 12, in some embodiments, the display apparatus 200 can also execute the following process, including: in response to the screen-mirroring cast disconnection event, the display apparatus 200 can generate a disconnection instruction. The screen-mirroring cast disconnection event can be a disconnection screen-mirroring cast instruction sent by a remote controller, or it can be a disconnection screen-mirroring operation issued by a terminal device such as a mobile phone. This application does not make any specific limitations on this.

After the display apparatus 200 generates a disconnection instruction, the second application at the upper layer can capture the disconnection instruction and send the disconnection instruction to the first application through the data intercommunication relationship established with the first application. After the first application receives the disconnection instruction sent by the second application, it can send the disconnection instruction to other applications other than the first application and the second application. In this way, since the second application itself can be a screen-mirroring cast application, after receiving the disconnection instruction, it can perform the screen-mirroring operation by itself or through other applications. At the same time, the display apparatus 200 can control the display 260 to exit the second application according to the disconnection instruction. In this way, after the focus instruction is captured through the upper-level application interface, the underlying application can be notified through cross-process communication. The underlying application is exemplified as the first application. After receiving the focus instruction, the underlying application can send the focus instruction to other applications through the underlying application itself. On the one hand, mutual communication between multiple applications and the purpose of displaying multiple applications in the same window are realized. On the other hand, the problem that the first application cannot obtain the focus instruction can be solved.

After the focus instruction is issued, the second application at the top layer can capture the focus instruction and can forwards the focus instruction to the first application at the bottom layer. In this way, the event or task in the focus instruction can be forwarded or executed by the first application at the bottom layer, and other applications, such as middleware applications, can be notified to perform related operations. In this way, the purpose of displaying two or more applications simultaneously can be achieved, and in addition, all applications can obtain the focus instruction, thereby ensuring the smooth execution of the instructions in the display apparatus 200.

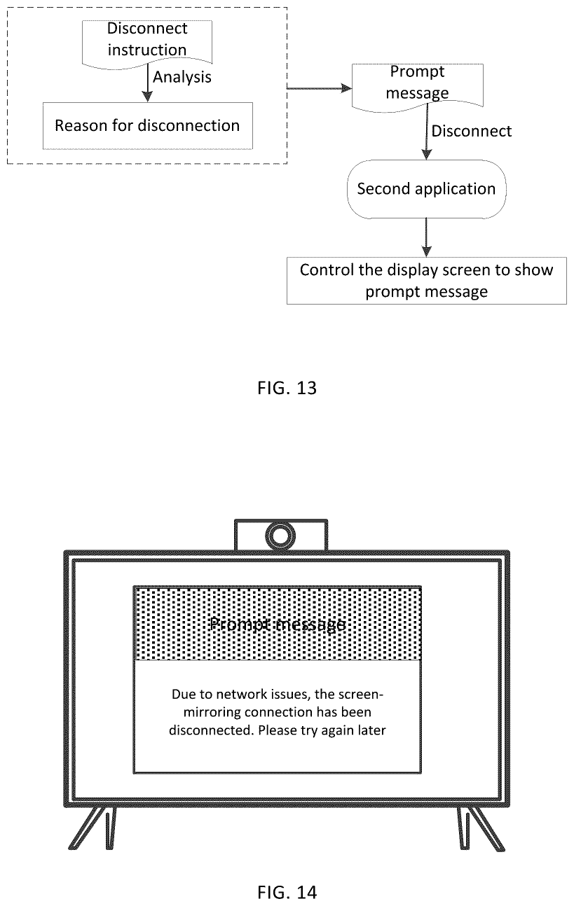

In order to make the user understand the reason why the second application disconnects the screen-mirroring, in some embodiments, the disconnection reason can also be carried in the disconnection instruction. FIG. 13 is a flowchart of parsing the disconnection reason based on the disconnection instruction according to some embodiments of the present application. As shown in FIG. 13, the user can be prompted with the reason for disconnecting the screen-mirroring in the following manner.

When the display apparatus 200 receives the disconnection instruction, it can first parse the disconnection reason of the disconnection instruction from the disconnection instruction. The screen-mirroring cast application can be issued by a terminal device such as a mobile phone. When the mobile phone wants to disconnect the screen-mirroring cast connection with the display apparatus 200, it can notify the second application to disconnect the screen-mirroring cast connection by sending a message, and at the same time can carry the reason for the disconnection, such as the mobile phone actively disconnecting, disconnecting due to network reasons, disconnecting due to conflicts between multiple screen-mirroring devices, etc. In some embodiments, after receiving the above disconnection reason, the second application can send a disconnection message to the underlying first application. In this way, the first application can send the disconnection message to other applications except the first application and the second application, and the display apparatus 200 can generate a prompt message according to the disconnection instruction and the disconnection reason.

FIG. 14 is a schematic diagram of a display apparatus displaying a prompt message according to some embodiments of the present application. As shown in FIG. 14, after the display apparatus 200 generates a prompt message based on the disconnection instruction and the disconnection reason, it can control the display 260 to display the prompt message when exiting the second application such as the screen-mirroring cast application. In this way, the user can intuitively understand the reason why the second application disconnects the screen-mirroring. It is understandable that after the prompt message is displayed on the display 260, the second application can no longer be displayed floating above the first application. That is to say, when the mobile phone sends a disconnection instruction, the interface of the second application can be destroyed and will no longer be displayed.

In some embodiments, the display apparatus 200 can also detect the running state of the first application. If the running state of the first application is abnormal, it can detect the screen-mirroring cast state of the second application; if the second application is in the screen-mirroring cast state, it can exit the second application; if the second application is in the non-screen-mirroring cast state, it can control the display 260 to display the second application in full screen.

The first application can run abnormally due to some reasons, for example, the first application configuration is abnormal, and the process is abnormal, etc. After the display apparatus 200 detects that the running state of the first application is abnormal, it can adaptively set the state of the second application. In some embodiments, after detection, if the running state of the first application changes to an abnormal operation and the second application can be in the screen-mirroring cast state, because the first application can no longer support the screen-mirroring cast state when an abnormality occurs, the first application can send an unprepared state to the second application, and the second application can be exited at this time to ensure the consistency of the cooperation between the first application and the second application. If the second application is in a non-screen-mirroring cast state, then there is no need to pay attention to whether the first application supports screen-mirroring. To ensure that the user can see the interface, the display apparatus 200 can directly control the display 260 to display the second application in full screen. In this way, although an abnormality occurs in the first application, other applications that have not performed screen-mirroring can still be displayed normally.

In order to support the user to switch the screen-mirroring display effect, in some embodiments, the display apparatus 200 can also perform corresponding operations according to the screen switching instructions input by the user, such as displaying the media data in the second application in horizontal or vertical screen according to the screen switching instructions.

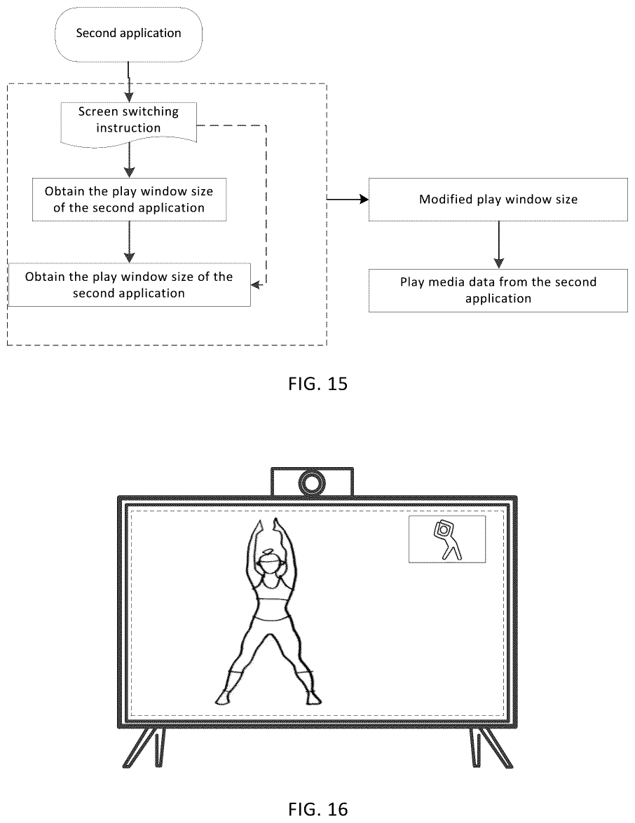

FIG. 15 is a flowchart of playing media data according to screen switching instructions according to some embodiments of the present application. As shown in FIG. 15, in some embodiments, the media data in the second application can be displayed horizontally or vertically according to the screen switching instructions in the following manner. In response to the user's screen switching instruction for the second application to play media data, the display apparatus 200 can obtain the playing window size of the second application. After obtaining the current playing window size, the display apparatus 200 can modify the playing window size according to the screen switching instruction, and play the media data in the second application according to the modified playing window size. It can be understood that the playing window size can include the width and height of the second application, i.e., the screen-mirroring cast application interface. When the width of the interface is greater than the height, the second application is played in horizontal mode; when the width is less than the height, the second application is played in vertical mode. The process of playing the media data according to the screen switching instruction is the process of switching the horizontal and vertical screen display effects.

The screen switching instruction can be issued by the user by switching the screen between horizontal and vertical on the mobile phone, or by switching the menu key on the remote controller, which is not limited in this application. It is understandable that the display apparatus 200 can receive the screen switching instruction in the following manner, and execute the corresponding process according to the received screen switching instruction.

When a screen switching instruction is issued through the mobile phone or the remote controller menu key, the second application first can obtain the screen switching instruction, and then the display apparatus 200 can obtain the current playing window size of the second application.

After obtaining the current playing window size, the display apparatus 200 can modify the playing window size according to the screen switching instruction. The screen switching instruction can be to switch the playback mode of the current second application from horizontal to vertical. Then, through calculation, the display apparatus 200 can calculate the aspect ratio corresponding to the vertical screen, that is, the modified playing window size. In this way, the media data in the second application can be played according to the modified playing window size.

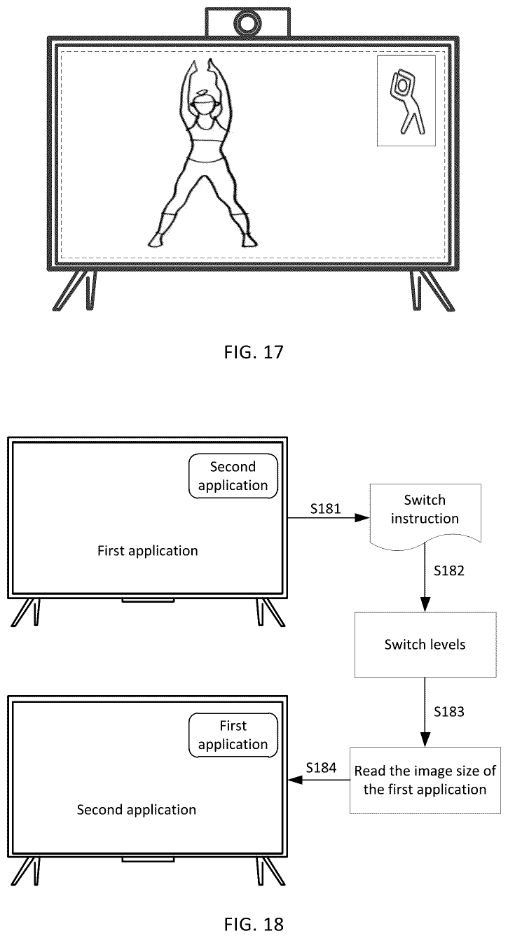

In some embodiments, when the mobile phone switches between horizontal and vertical modes or the remote controller menu key switches, the display apparatus 200 can modify the display size of the screen-mirroring cast application interface according to the width and height of the video stream. At the same time, certain display rules can be set. For example, FIG. 16 is a schematic diagram of a second application displayed in a horizontal state according to some embodiments of the present application. If the second application after screen-mirroring is in a horizontal screen display state, the second application can be displayed floating in the upper right corner of the current window as shown in FIG. 16. FIG. 17 is a schematic diagram of a second application displayed in a vertical state according to some embodiments of the present application. If the second application after screen-mirroring is in a vertical display state, the second application can be displayed in a floating manner on the right side of the current window as shown in FIG. 17.

In some embodiments, the process of displaying the media data in the second application in a horizontal or vertical manner according to the screen switching instruction can be implemented in the following manner. If the current video stream is in horizontal mode, it can float in the upper right corner by default, with a fixed width and height that scales according to the original proportion. Dynamically set the size of the screen-mirroring cast application interface through specific fields such as the setLayoutParams field. If the current video stream is in vertical mode, it can float on the right by default, with a fixed height and width that scales according to the proportion of the mobile video stream. The size of the screen-mirroring cast application interface can be dynamically set through setLayoutParams field. The remote controller can also follow this logic. The specific width and height of the screen-mirroring cast application interface can be calculated as follows.

The width of the video stream is recorded as VideoWidth, and the height of the video stream is recorded as VideoHeight. In some embodiments, if VideoWidth≥VideoHeight, the width of the parent layout is a fixed width, recorded as X, and the height of the parent layout is X*VideoHeight/VideoWidth. If VideoWidth<VideoHeight, the height of the parent layout is a fixed height, recorded as Y, and the width of the parent layout is Y*VideoWidth/VideoHeight. Among them, the parent layout is the width and height of the upper screen-mirroring cast application interface.

In some embodiments, the width and height calculation method when the mobile phone switches the horizontal and vertical screens or switches the remote controller menu key can also be to obtain the width and height of the current parent layout, which are recorded as ViewWidth and ViewHeight respectively. If VideoWidth≥VideoHeight, the height of the parent layout is fixed, recorded as Y, and the width of the parent layout is Y*VideoHeight/VideoWidth. If VideoWidth<VideoHeight, the height of the parent layout is fixed, recorded as Y, and the width of the parent layout is Y*VideoWidth/VideoHeight. It should be noted that the above calculation process is only an example and does not represent the actual calculation process. There can be other calculation methods or calculation steps, etc., which are not limited to this application, and the above calculation method does not constitute a limitation on the present application.

It can be seen from the above technical solutions that the processing method for a display apparatus provided by the above embodiments not only can realize the simultaneous display of two or more applications in the same window and solve the problems of application interactivity, large limitations and high maintenance costs during the same-screen display of applications, but can also switch the horizontal and vertical screen display effects of the second application according to the screen switching instructions. In this way, the utilization rate of the display apparatus 200 can be improved while satisfying the user experience.

Based on the above-mentioned processing method for a display apparatus, a display apparatus 200 according to some embodiments of the present application can include a display 260, which can be configured to display a user interface and/or screen-mirroring cast data; a communicating device 220, which can be configured to communicate with an external device and/or be connected with a terminal device for screen-mirroring according to a communication protocol; a memory, which can be configured to store computer instructions and/or data associated with the display apparatus; at least one processor 250, which can connected with the display 260, the communicating device 220 and the memory, and can be configured to execute the computer instructions to cause the display apparatus 200 to perform: in response to a screen-mirroring cast instruction, obtaining a preparation state of a first application and starting a second application; where the first application is an application displayed in a current user interface, and the second application is a screen-mirroring cast application; the preparation state is used to indicate whether the first application supports floating display; based on that the preparation state is a state that supports floating, controlling the display to display the second application above the first application in a floating manner; based on that the preparation state is a state that does not support floating, controlling the display to display the second application in a full-screen manner.

It can be seen from the above technical solution that the display apparatus 200 provided in the above embodiments responds to the screen-mirroring cast instruction, the preparation state of the first application can be obtained, and the second application can be started. if the preparation state is a state that supports floating, the display 260 can be controlled to float and display the second application above the first application; if the preparation state is a state that does not support floating, the display 260 can be controlled to display the second application in full screen. When two applications are displayed simultaneously in the same window in the embodiments of the present application, since the two applications are independent of each other and are not integrated into the same application, the first application and the second application do not rely on native interfaces, and the applications are more expandable, more operable, easier to maintain, and have reduced maintenance costs. In addition, since interactive communication is established between the two applications, the two applications can interact with each other while being displayed in superimposed form. The two applications can communicate with each other and perform related operations as needed, thus solving the problems of application interactivity, large limitations, and high maintenance costs during the same-screen display of applications.

In addition, the display apparatus 200 can also establish a screen-mirroring cast connection with other terminal devices, so that the display apparatus 200 can play and display the image content in other terminal devices.

In the related art, the floating window can be set based on the native interface to display applications on the same screen, which cannot enable data communication between the various display windows. Then, when the display apparatus 200 is performing the same-screen display, the user cannot control the application interface displayed by the display apparatus 200 through the control device 100 such as the remote controller, which leads to low response efficiency of the display apparatus 200 during the same-screen display of the application, thereby reducing the user experience. Integrating the SDKs of various applications into the same application can enable data communication between multiple applications. However, the method of integrating the SDKs of multiple applications into the same application can cause the application integrated with multiple SDKs to have problems such as complex interactivity and poor scalability during the maintenance process, and can also affect the operating efficiency of the display apparatus 200.

Based on the above application scenarios, in order to improve user experience and alleviate the problem of low response efficiency of the display apparatus 200 during the same-screen display of applications, some embodiments of the present application provide another processing method for a display apparatus. As shown in FIG. 18, the method specifically can include the following steps.

S181: receive a switching instruction for switching a display position of an application.

The display apparatus 200 can obtain a variety of control instructions input by the user, where some control instructions are control instructions for switching the display position of the application as switching instructions. In some embodiments, the switching instruction can be issued by a terminal device 300, such as a mobile phone, etc.; it can also be issued by a remote controller provided with the display apparatus 200; or it can be issued by an external touch component of the display apparatus 200. The present application does not make specific limitations.

Obviously, when the user inputs the switching instruction, the display apparatus 200 is already in a state of displaying applications on the same screen. The floated display is a special display state. Therefore, when the display apparatus 200 displays an application in a floating manner, the display apparatus 200 can display the user interface of the application through a floating window only after the application enters a floating state and is ready.

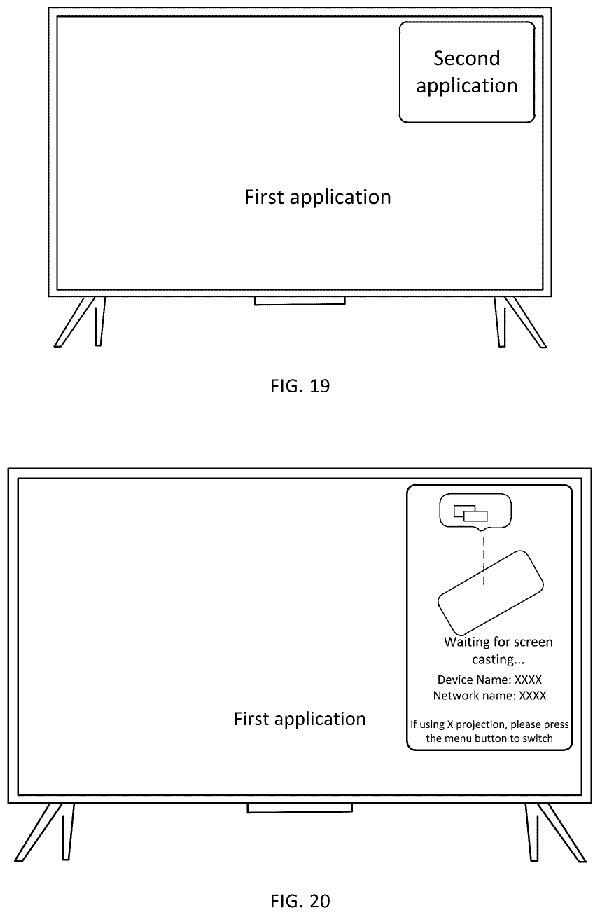

Therefore, in some embodiments, the display apparatus 200 can receive a startup instruction for displaying an application screen, and in response to the startup instruction, the preparation state of the first application can be obtained and the second application can be started. As shown in FIG. 19, if the preparation state is a state of preparation completed, the display apparatus 200 can control the display 260 to display the second application in a floating manner on the upper layer of the first application, so that the display apparatus 200 can display the user interfaces of multiple applications on the same screen. If the preparation state is an unprepared state, the display apparatus 200 can control the display 260 to display the second application in full screen, so that the user can view the user interface of the second application on a large screen.

For example, the display apparatus 200 can be displaying the user interface of the first application. At this time, the user can send a startup instruction to display the second application screen to the display apparatus 200. The display apparatus 200 can detect the preparation state of the first application, and detect that the first application is not fully prepared. If the first application is in an unprepared state, it means that the current state does not support displaying the user interfaces of the first application and the second application on the display apparatus 200 at the same time. Then, the display apparatus 200 can control the display 260 to display the user interface of the second application in full screen for the user to watch.

Furthermore, in order to facilitate the display apparatus 200 to obtain the state of the first application, in some embodiments, the display apparatus 200 can also receive a state message of the first application, and parses an identifier contained in the state message to determine the preparation state of the current application.

For applications that can only be started on the startup interface, the display apparatus 200 can require the user to perform corresponding operations on the startup interface before floating the user interface of the application to complete the startup. Therefore, in some embodiments, if the second application is a non-background service application, the display apparatus 200 can control the display 260 to display an operation prompt interface when the second application is started. After the display 260 displays the operation prompt interface, the display apparatus 200 can also monitor the startup state of the second application. If the second application is started, the display 260 can be controlled to close the operation prompt interface.

Furthermore, when the display apparatus 200 displays the operation prompt interface, the user can also input an operation instruction to the display apparatus 200 to change the corresponding operation prompt interface to select a startup method for the application. That is, in some embodiments, the display apparatus 200 can receive an operation instruction input by a user for changing an operation interface, and change a corresponding operation prompt interface in response to the operation instruction to switch the startup mode.

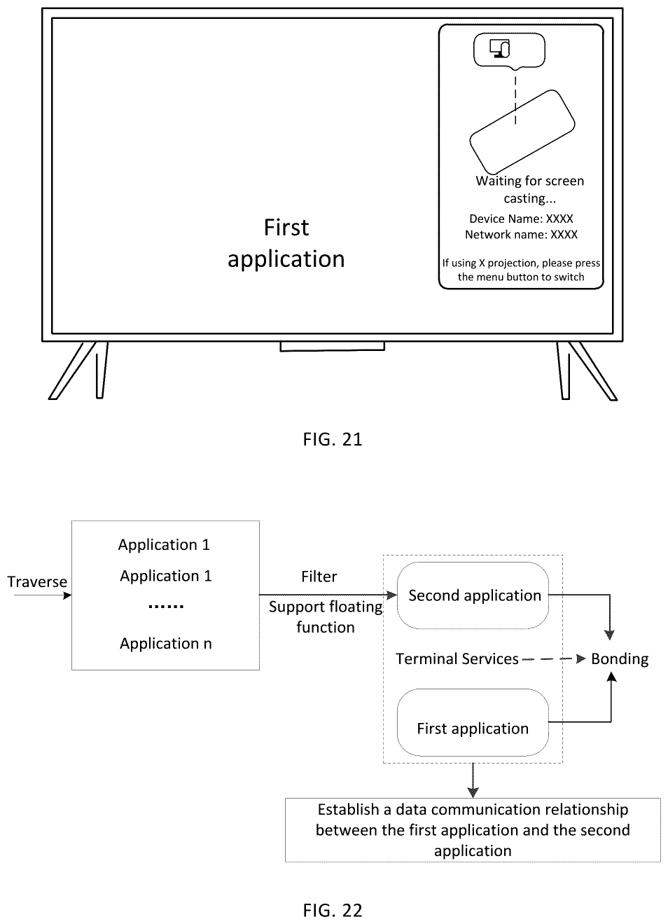

For example, taking the screen-mirroring cast application as an example, after the user starts the screen-mirroring function in the display apparatus 200, the display apparatus 200 can display the operation prompt interface of the screen-mirroring cast connection as shown in FIG. 20. After the user clicks a designated button on the remote controller, the display apparatus 200 can respond to the user's operation and switch to an operation prompt interface as shown in FIG. 21 on the display 260. The user can perform corresponding operations on the screen-mirroring device synchronously according to the operation prompt interface to establish a screen-mirroring relationship with the display apparatus 200. Furthermore, after the screen-mirroring device establishes a screen-mirroring cast connection relationship with the display apparatus 200, the display apparatus 200 can close the operation prompt interface.

It can be understood that the first application and the second application in the embodiments of the present application are applications that establish a data intercommunication relationship with each other and both support floating display.

Therefore, in order to establish a data intercommunication relationship between the first application and the second application, in some embodiments, the display apparatus 200 can also traverse the applications in the display apparatus 200 and select applications that support the floating function as the first application or the second application. The client services in the first application and the second application are then bonded to establish a data intercommunication relationship between the first application and the second application. That is, as shown in FIG. 22, the display apparatus 200 can traverse all the deployed applications by itself, and select the applications that support the floating function from all the applications. After the applications supporting the floating function are selected, the client services between the applications are bonded, so that a data intercommunication relationship between the first application and the second application can be established, so that the first application and the second application can perform data communication.

For example, the first application is a background service application. After the second application is started, the display apparatus 200 can traverse the current whole applications through the metadata information to determine whether there is an application that supports floating. If there are applications that support floating, the agreed client services can be bonded in sequence, thereby completing the data intercommunication between the applications that support floating in the display apparatus 200. The state information of the first application is received, and it is parsed that the preparation state of the first application is preparation completed. As shown in FIG. 19, the display apparatus 200 can display the user interface of the second application in a floating window on the upper layer of the first application.

Obviously, the display apparatus 200 can display the first application in full screen, and the user interface of the first application can be scaled according to the size of the display 260 at a preset ratio. However, when the display apparatus 200 displays the second application through the floating window, it is necessary to set the size of the floating window according to the image state of the second application before the appropriate image size can be displayed on the display 260.

Therefore, in order to facilitate setting of the size of the floating window, in some embodiments, the display apparatus 200 can obtain the media data of the second application, and parse the image size in the media data to obtain the image state of the second application screen. The image state can include a horizontal state and a vertical state. If the image state is horizontal, the floating window width can be determined to be the default width, and the aspect ratio of the image size is obtained, and the window height can be calculated according to the default width and aspect ratio; if the image state is vertical, the window height can be determined to be the default height, and the aspect ratio of the image size is obtained, and the window width can be calculated according to the default height and aspect ratio.

For example, taking the second application as a screen-mirroring cast application, the media data of the screen-mirroring cast application, that is, the video stream of the screen-mirroring cast application, can be obtained. The width of the video stream is recorded as VideoWidth, and the height of the video stream is recorded as VideoHeight. When setting a floating window on the upper layer of the first application, the display apparatus 200 can obtain the width and height of the current parent layout, can record the width of the parent layout as ViewWidth, and can record the height of the parent layout as ViewHeight. And the width and height of the floating window can be calculated according to the following formula.

If VideoWidth≥VideoHeight, the width of the parent layout can be determined to be fixed, recorded as X, then the height of the parent layout is X*VideoHeight/VideoWidth, and the width and height of the floating window are the same as the width and height of the parent layout. If VideoWidth<VideoHeight, the height of the parent layout can be determined to be fixed, recorded as Y, then the height of the parent layout is Y*VideoWidth/VideoHeight, and the width and height of the floating window are the same as the width and height of the parent layout. The display apparatus 200 can set a floating window according to the set width and height dimensions to display the user screen of the screen-mirroring cast application through the floating window.

S182: in response to the switching instruction, switch the levels of the first application and the second application to control the display to display the user interface of the second application in full screen.

After the display apparatus 200 displays the second application through the set floating window, the user interface of the second application can be displayed on the upper layer of the first application. Furthermore, the first application and the second application are applications that establish a data intercommunication relationship with each other and both support floating display. Therefore, after receiving the switching instruction, the display apparatus 200 can exchange the levels of the first application and the second application, so that the user interface of the second application can be displayed in full screen and the user interface of the first application can be displayed in floating.

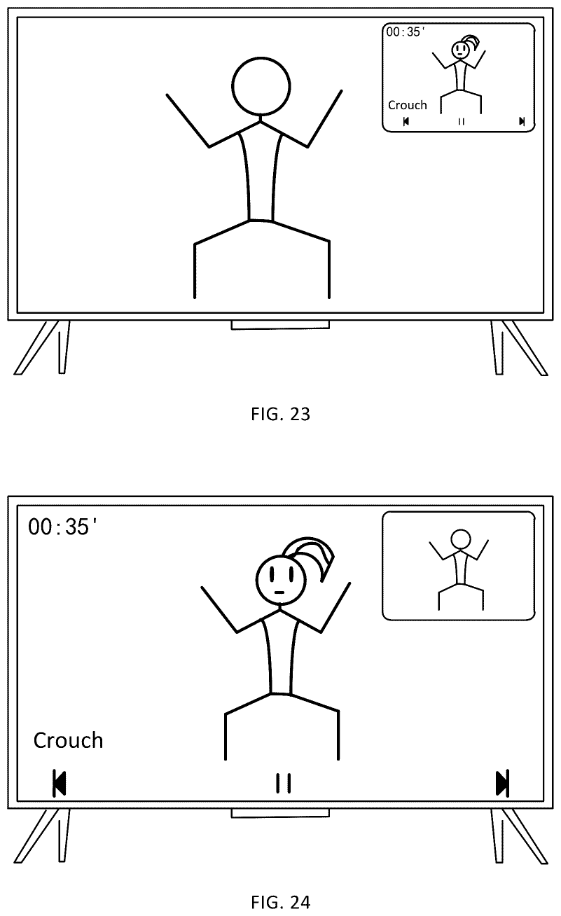

For example, take the first application as a fitness mirror application of the display apparatus 200 and the second application as a screen-mirroring cast application. As shown in FIG. 23, the display 260 can display the image of the fitness mirror application in full screen, and can display the image of the screen-mirroring cast application in floating mode. That is, the fitness mirror application is the lower layer application in FIG. 23, and the screen-mirroring cast application is the upper-layer application in FIG. 23. At this time, if the user wants to enlarge the image in the screen-mirroring cast application, a switching instruction can be send to the display apparatus 200 through the remote controller. After receiving the switching instruction, the display apparatus 200 can exchange the levels of the fitness mirror application and the screen-mirroring cast application; switch the screen-mirroring cast application to the lower-level application, and switch the fitness mirror application to the upper-level application.

In addition, in order to facilitate the first application and the second application to perform operations corresponding to the switching instruction, in some embodiments, the display apparatus 200 can also monitor the focus event of the first application and encapsulate the event for switching the screen position into a switching instruction. Then the display apparatus can control the first application to execute the switching instruction, and forward the switching instruction to the second application, so that the second application can execute the switching instruction. That is, since the first application and the second application are in a data intercommunication relationship, the display apparatus 200 can capture the focus event only through the lower layer application. After capturing the focus event of switching the screen position, the lower layer application can notify the upper-layer application to exchange the layer and display position.

Furthermore, in some embodiments, after detecting a focus event, the display apparatus 200 can further parse the focus event. At the same time, according to the analysis result, the focus event can be encapsulated as a control instruction corresponding to the event. For example, an event for rotating the horizontal or vertical screen image is encapsulated as a rotation instruction. The display apparatus 200 can parse the application targeted by the control instruction, execute the control instruction through the first application, and/or control the first application to forward the control instruction to the second application so that the application corresponding to the control instruction can perform a corresponding operation.

For example, the first application can be a fitness mirror application, and the second application can be a screen-mirroring cast application. Firstly, the user can start the fitness mirror application in the display apparatus 200. The fitness mirror application can start a window, which is named W1, can set the type to X, capture the focus event, and bond the client service to communicate. At this time, the fitness mirror application can be a lower layer application of the display apparatus 200. Then, after the display apparatus 200 receives the screen-mirroring message, the screen-mirroring cast application can also start a window, named W2, can set the type to Y, cannot capture the focus event, and Y>X. At this time, as shown in FIG. 23, the screen-mirroring cast application can be an upper-layer application of the display apparatus 200. The display apparatus 200 can capture the focus event through the lower layer W1. When W1 captures the focus event, it can notify W2 to switch the horizontal and vertical screens or interchange their positions, and adjust the UI synchronously.

S183: obtain the image size of the first application, and set a floating window on the upper layer of the second application according to the image size.

After the display apparatus 200 switches the levels of the first application and the second application in response to the switching instruction, since the user interfaces of the first application and the second application can have different screen ratios, it is also necessary to reset the floating window according to the image size of the first application so as to display the first application through a floating window of an appropriate size.

To facilitate planning of the floating window size, in some embodiments, the display apparatus 200 can obtain the window size of the first application. If the window width of the first application is greater than or equal to the window height, the window height can be obtained, and a floating window can be set on the upper layer of the second application according to the window height and the image size; if the window width of the first application is less than the window height, the window width can be obtained, and a floating window can be set on the upper layer of the second application according to the window width and the image size, so as to display the user interface of the first application in the floating window of an appropriate size.

For example, obtaining the media data of the first application, that is, the video stream in the first application. The width of the video stream is recorded as VideoWidth, and the height of the video stream is recorded as VideoHeight. When setting a floating window on the upper layer of the second application, obtain the width and height of the current parent layout, record the width of the parent layout as ViewWidth, and record the height of the parent layout as ViewHeight. The width and height of the floating window can be calculated according to the following formula.

If ViewWidth≥ViewHeight, and VideoWidth≥VideoHeight, the height of the parent layout can be determined to be a fixed height, recorded as Y, then the width of the parent layout is Y*VideoHeight/VideoWidth, the width of the floating window is Y*VideoHeight/VideoWidth, and the height of the floating window is Y*VideoHeight*VideoHeight/VideoWidth/VideoWidth. If ViewWidth≥ViewHeight, and VideoWidth<VideoHeight, the height of the parent layout can be determined to be a fixed height, recorded as Y, then the height of the parent layout is Y*VideoWidth/VideoHeight, and the width and height of the floating window are the same as the width and height of the parent layout.

If ViewWidth<ViewHeight, and VideoWidth≥VideoHeight, the width of the parent layout can be determined to be fixed width, recorded as X, then the height of the parent layout is X*VideoHeight/VideoWidth, and the width and height of the floating window are the same as the width and height of the parent layout. If ViewWidth<ViewHeight, and VideoWidth<VideoHeight, the width of the parent layout can be determined to be fixed width, recorded as X, then the height of the parent layout is X*VideoWidth/VideoHeight, the width of SurfaceView is X*VideoWidth*VideoWidth/VideoHeight/VideoHeight, and the height of the floating window is X*VideoWidth/VideoHeight. After setting the floating window of the first application, the display apparatus 200 can set the floating window according to the set size to display the user interface of the first application through the floating window.

Before switching levels, the display apparatus 200 can detect a focus event through the first application of the lower layer. Similarly, in order to facilitate the interactive process within the display apparatus 200, after switching the levels of the first application and the second application, the first application can be changed to an upper layer application. At this time, the display apparatus 200 still can monitor the focus event of the first application, and encapsulate the focus event into a control instruction corresponding to the event. The first application can be controlled to execute the control instruction, or the control instruction can be forwarded to the second application so that the second application can execute the control instruction. That is, the display apparatus 200 can always keep capturing the focus event through the first application.

Therefore, in some embodiments, the display apparatus 200 can detect the level position of the first application, and mark the window of the first application as a target window according to the level position, monitor the focus event of the target window, and encapsulate the focus event into a control instruction corresponding to the event. In this way, no matter how the levels of the first application and the second application are switched, the display apparatus 200 can always capture the focus event through the first application, and then forward the focus event through the first application, thereby simplifying the interaction process within the display apparatus 200.

S184: control the display to display the user interface of the first application via a floating window.

After the display apparatus 200 sets the size of the floating window, the user interface of the first application can be displayed in a floating manner on an upper layer of the second application through the floating window.

In some embodiments, after the display apparatus 200 sets the size of the floating window, it can display the floating window in a preset display area, such as the upper right corner, upper left corner, etc. of the second application, and then can reasonably display the user interfaces of the first application and the second application on the display 260 at the same time.

For example, taking screen-mirroring as an example, the first application can be a fitness mirror application, and the second application can be a screen-mirroring cast application. As shown in FIG. 23, the display 260 can display the image of the fitness mirror application in full screen, and display the image of the screen-mirroring cast application in floating mode. At this time, if the user wants to enlarge the image in the screen-mirroring cast application, a switching instruction can be send to the display apparatus 200 through the remote controller. After receiving the switching instruction, the display apparatus 200 can switch the levels of the fitness mirror application and the screen-mirroring cast application, and reset the floating window of the fitness mirror application. After the floating window of the fitness mirror application is set, the display apparatus 200 can control the display 260 to display the user interface shown in FIG. 24.

In addition, it can be seen from the above embodiments that the display apparatus 200 can capture focus events through the underlying application, so that the user can input a rotation instruction of the horizontal or vertical image to the display apparatus 200 to change the horizontal or vertical state of the image in the floating window. However, in some scenarios, the application's user interface can automatically switch between horizontal and vertical modes based on the device's placement.

Therefore, in some embodiments, the display apparatus 200 can also obtain the media data of the target application, where the target application can be the first application or the second application. The image size in the media data can be parsed to obtain the image state of the target application image, where the image state can include a horizontal state and a vertical state. If the image state of the target application image changes, a screen rotation instruction for the horizontal or vertical image is generated, so that the target application can execute the rotation instruction. That is, the display apparatus 200 can monitor whether the horizontal or vertical state of the application image changes according to the media data of the application, so as to synchronously adjust the horizontal or vertical state of the image displayed in each display window of the display 260 when the horizontal or vertical state of the application image changes.

Obviously, when rotating the screen in a horizontal or vertical direction, the display apparatus 200 can also need to reset the size of the window. Therefore, in some embodiments, if the image state of the target application image changes, the display apparatus 200 can obtain the window size of the target application. If the window width of the target application is greater than or equal to the window height, the window height can be obtained, and a floating window can be set on the upper layer of the second application according to the window height and the image size; if the window width of the target application is less than the window height, the window width can be obtained, and a floating window can be set on the upper layer of the second application according to the window width and the image size.

For example, taking the second application as a screen-mirroring cast application, the display apparatus 200 can obtain the media data of the second application, that is, the video stream of the second application. The width of the video stream is recorded as VideoWidth, and the height of the video stream is recorded as VideoHeight. The placement state of the screen-mirroring device has changed, so the displayed image state has also changed. When the image state of the screen-mirroring cast application is detected to have changed, the width and height of the current parent layout can be obtained, and the width of the parent layout can be recorded as ViewWidth, and the height of the parent layout can be recorded as ViewHeight. The width and height of the window can be calculated according to the following formula.

If ViewWidth≥ViewHeight, and VideoWidth≥VideoHeight, the height of the parent layout can be determined to be a fixed height, recorded as Y, then the width of the parent layout is Y*VideoHeight/VideoWidth, the width of the floating window is Y*VideoHeight/VideoWidth, and the height of the floating window is Y*VideoHeight*VideoHeight/VideoWidth/VideoWidth. If ViewWidth≥ViewHeight, and VideoWidth<VideoHeight, the height of the parent layout can be determined to be a fixed height, recorded as Y, then the height of the parent layout is Y*VideoWidth/VideoHeight, and the width and height of the window are the same as the width and height of the parent layout.

If ViewWidth<ViewHeight, and VideoWidth≥VideoHeight, the width of the parent layout can be determined to be fixed width, recorded as X, then the height of the parent layout is X*VideoHeight/VideoWidth, and the width and height of the floating window are the same as the width and height of the parent layout. If ViewWidth<ViewHeight, and VideoWidth<VideoHeight, the width of the parent layout can be determined to be fixed width, recorded as X, then the height of the parent layout is X*VideoWidth/VideoHeight, the width of SurfaceView is X*VideoWidth*VideoWidth/VideoHeight/VideoHeight, and the height of the window is X*VideoWidth/VideoHeight. After resetting the floating window of the second application, the display apparatus 200 can set the floating window according to the set size to display the user interface of the second application through the floating window.

It should be noted that the calculation process involved in the above embodiments is only for illustrative purposes and does not represent the actual calculation process. There can be other calculation methods or calculation steps, etc., which are not limited to the present application, and the above calculation method does not constitute a limitation on the present application.

In addition, when the applications are displayed on the same screen, the user can close any application at any time to close its corresponding display window. That is, in some embodiments, the display apparatus 200 can receive a close instruction and send the close instruction to the first application. The close instruction can be executed by the first application, and/or the first application can be controlled to forward the close instruction to the second application, so as to control the second application to execute the close instruction. After the display apparatus 200 switches the level, the first application can be changed to an upper level application. At this time, the display apparatus 200 can capture the focus event through the upper layer first application, and encapsulate the event for closing the application in the focus event into a close instruction, and send it to the display apparatus 200. If the close instruction is a closing event of the first application, the close instruction can be executed by the first application; if the close instruction is a close instruction of the second application, the close instruction can be forwarded to the second application by the first application, so that the second application can execute the close instruction.

Obviously, after the application is closed, the display 260 can no longer display the user interface of the application. Then, if the user closes the second application, the display 260 can only display the user interface of the first application. Since the first application is in a floating display state, if only the second application is closed, the display 260 can still display the first application through the floating window, which can cause most of the display area in the display 260 to be wasted, thereby reducing the user experience.

Therefore, in some embodiments, the display apparatus 200 can also detect the close state of the first application and the second application. If the second application is in a close state and the first application is not in a close state, the display 260 can be controlled to display the user interface of the first application in full screen.

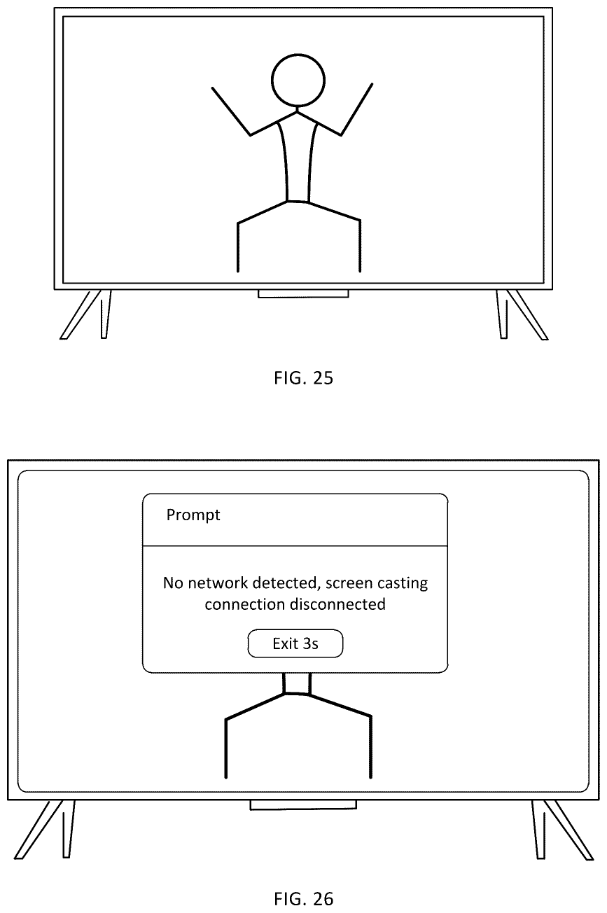

For example, taking screen-mirroring as an example, the first application can be a fitness mirror application, and the second application can be a screen-mirroring cast application. When the display apparatus 200 displays the user interface shown in FIG. 24, the user can close the screen-mirroring cast application of the display apparatus 200, and the display apparatus 200 can destroy the display window of the screen-mirroring cast application. At the same time, as shown in FIG. 25, the display apparatus 200 can also display the user interface of the fitness mirror application in full screen.

It is understandable that the close instruction is not limited to the user input method, and the application can be closed due to other reasons, such as network disconnection, conflict disconnection, etc. Therefore, in some embodiments, after detecting that the connection between the application and the display apparatus 200 is abnormal, the display apparatus 200 can automatically generate a close instruction so that the display apparatus 200 can close the application.

For the case where the application is not closed actively by the user, in order to facilitate the user to understand the reason for closing the application, in some embodiments, the close instruction can also carry the reason for closing the application. When encapsulating the close instruction, the display apparatus 200 can also encapsulate the close reason into the close instruction. In this way, when executing the close instruction, the display apparatus 200 can also analyze the close reason and control the display 260 to display corresponding prompt information according to the close reason.

For example, taking screen-mirroring as an example, the first application can be a fitness mirror application, and the second application can be a screen-mirroring cast application. When the display apparatus 200 displays the user interface shown in FIG. 23, it can receive a close instruction of the screen-mirroring cast application due to network reasons. The display apparatus 200 can parse the close reason from the close instruction, and notify other applications of the display apparatus 200 of the close reason and the close instruction through the underlying screen-mirroring cast application, so that the display apparatus 200 can display the prompt information shown in FIG. 26 in the display 260 according to the close reason.

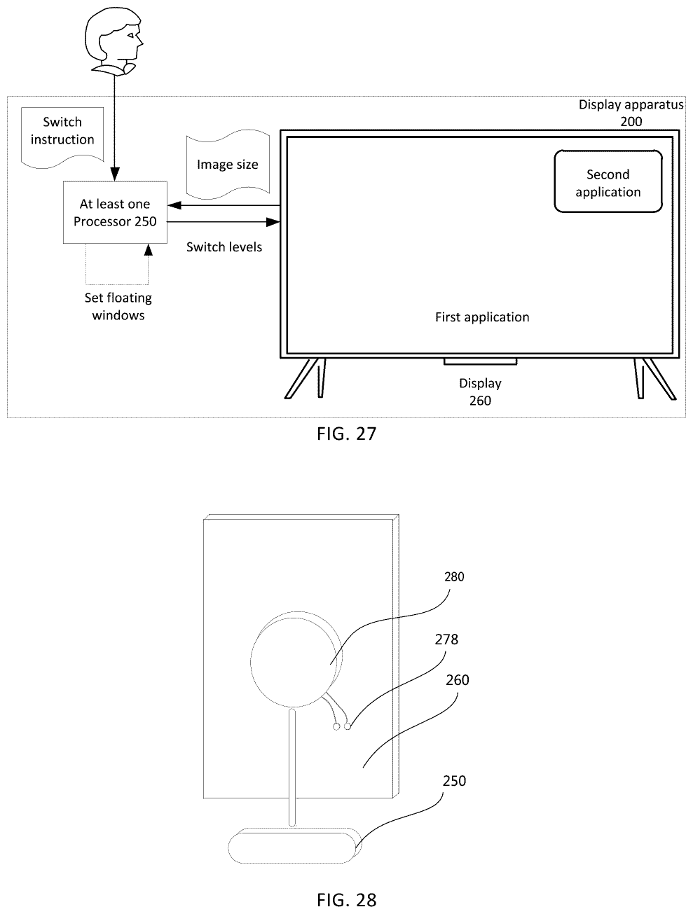

Based on the above-mentioned another processing method for a display apparatus, a display apparatus 200 in some embodiments of the present application, as shown in FIG. 27, can include: a display 260 and at least one processor 250. The display 260 can be configured to display the user interface of the first application, and to display the user interface of the second application on the upper layer of the first application. As shown in FIG. 6, the at least one processor 250 can be configured to execute computer instructions stored in the memory of the display apparatus 200 to cause the display apparatus 200 to perform the following operations.

S181: receive a switching instruction for switching an application display position.

S182: in response to the switching instruction, switch the levels of the first application and the second application to control the display to display the user interface of the second application in full screen.

The first application and the second application are applications that establish a data intercommunication relationship with each other and both support floating display.

S183: obtain the image size of the first application, and set a floating window on the upper layer of the second application according to the image size.

S184: control the display to display the user interface of the first application via a floating window.

It can be seen from the above technical solution that the display apparatus of some embodiments of the present application and another processing method for the display apparatus can respond to a switching instruction for switching the display position of the application, switch the levels of the first application and the second application, so as to control the display 260 to display the user interface of the second application in full screen. The first application and the second application can be applications that establish a data intercommunication relationship with each other and both support floating display. The image size of the first application can be obtained and a floating window on the upper layer of the second application can be set according to the image size. The display 260 can be controlled to display the user interface of the first application through a floating window, so as to quickly respond to the switching instruction input by the user when the display apparatus displays the applications on the same screen, thereby improving the user experience.

In some embodiments, as shown in FIG. 28, the display apparatus 200 can include at least one processor 250, a display 260, a terminal interface 278 extending from a gap on the back panel, and a rotating component 280 connected with the back panel. The rotating component 280 can rotate the display screen. From the perspective of viewing from the front of the display apparatus, the rotating component 280 can rotate the display screen to a vertical state, i.e., a state in which the vertical side length of the screen is greater than the horizontal side length, and the rotating component 280 can also rotate the screen to a horizontal state, i.e., a state in which the horizontal side length of the screen is greater than the vertical side length.

In some embodiments, the rotating component 280 can include components such as a driving motor and a rotating shaft. Among them, the driving motor can be connected with at least one processor 250 and output a rotation angle under the control of at least one processor 250; one end of the rotating shaft is connected with the power output shaft of the driving motor, and the other end is connected with the display 260, so that the display 260 can be fixedly mounted on a wall or a bracket through the rotating component 280.

The rotating component 280 can also include other components, such as a transmission component, a detection component, etc. Among them, the transmission component can adjust the speed and torque output by the rotating component 280 through a specific transmission ratio, and can be a gear transmission method; the detection component can be composed of sensors arranged on the rotating shaft, such as angle sensors, posture sensors, etc. These sensors can detect parameters such as the rotation angle of the rotating component 280, and send the detected parameters to at least one processor 250, so that at least one processor 250 can determine or adjust the state of the display apparatus 200 according to the detected parameters. In practical applications, the rotating component 280 can include but not limited to one or more of the above-mentioned components.

In the related art, the display apparatus 200 can display applications on the same screen by setting a floating window based on a native interface, which is highly dependent on the native interface and cannot enable data communication between various display windows. Then, if the rotating component 280 of the display apparatus 200 rotates, the user interface of the display apparatus 200 cannot be dynamically adjusted according to the rotation event of the rotating component 280. By integrating the SDKs of multiple applications into the same application, data communication between the multiple applications can be realized, so that the display apparatus 200 can adjust the display screen direction of each application according to the rotation event of the rotating component 280. However, integrating the SDKs of multiple applications into the same application can cause problems such as complex interactivity and poor scalability during the maintenance of the application integrating multiple SDKs, resulting in slow response speed of the display apparatus 200 when rotating the user screen of each application, thereby reducing the user experience.

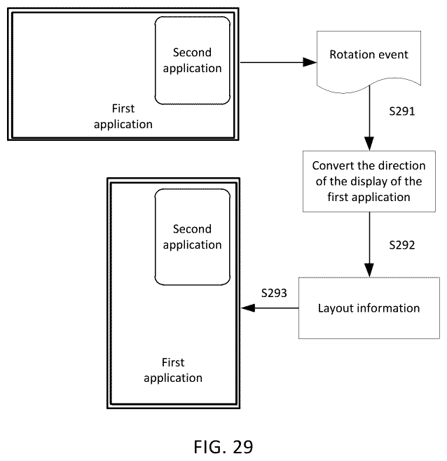

Based on the above application scenarios, in order to improve user experience and alleviate the problem of slow response speed of the display apparatus 200 when rotating the user screen of each application, some embodiments of the present application provide a third processing method for the display apparatus. As shown in FIG. 29, the method can include the following steps.

S291: in response to a rotation event of the rotating component, convert the display screen direction of the first application, and obtain the window size and image size of the second application.

The display apparatus 200 can monitor the rotation event of the rotating component 280, so that when the rotating component 280 rotates, the display apparatus 200 can adjust the display screen direction of the display 260 accordingly. Therefore, in some embodiments, the display apparatus 200 can monitor the rotation direction of the rotating component 280 and change the global screen direction according to the rotation direction. The global screen direction is the display screen direction of the display 260, and the display screen direction can include horizontal or vertical.

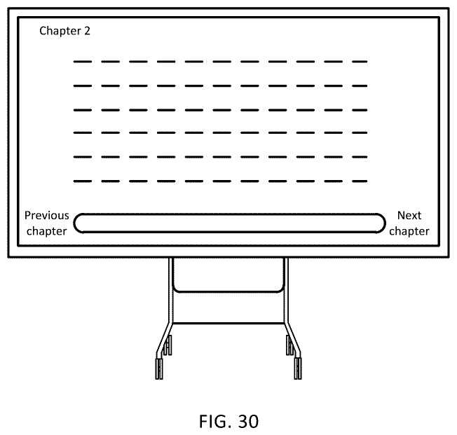

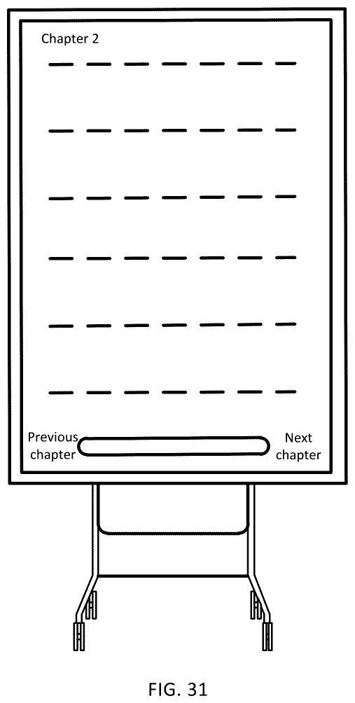

For example, when the display 260 of the display apparatus 200 is in the state shown in FIG. 30, the user is reading novel A through the display apparatus 200. At this time, the global screen direction of the display apparatus 200 is horizontal. In order to facilitate reading of the content of novel A, the user adjusts the display 260 to the state shown in FIG. 31. At this time, the image displayed by the display 260 is as shown in FIG. 31, and the global screen direction of the display apparatus 200 is vertical.

It is understandable that the display apparatus 200 can automatically determine the horizontal or vertical state of the display 260 according to various parameters in the rotating component 280. For example, when the angle between the display 260 and the ground is 85°, it can be determined that the display 260 is in the vertical state. The present application does not limit this.

It can be seen from the above embodiments that based on that the rotating component 280 rotates, the display apparatus 200 can change the global screen direction. Similarly, based on that the global screen direction changes, the application displayed by the display apparatus 200 can also need to adjust the display screen direction synchronously. In order to adapt the display window of the application to the direction state of the display 260, when the application is started, it is necessary to set the display direction of the application according to the global screen direction of the display apparatus 200 to adapt to the image content displayed by the display 260.

Therefore, in some embodiments, the display apparatus 200 can monitor the rotation direction of the rotating component 280 and change the global screen direction according to the rotation direction, where the global screen direction is the display screen direction of the display 260. In response to the startup instruction for displaying the first application image, the display apparatus 200 can obtain the global screen direction and control the display 260 to display the user interface of the first application in full screen according to the global screen direction. That is, the display apparatus 200 can obtain the display screen direction of the current display 260 through the rotating component 280 as the global screen direction of the display apparatus 200. Based on that the user starts the first application, the display apparatus 200 can set the display direction of the first application according to the global screen direction and display the first application in full screen.

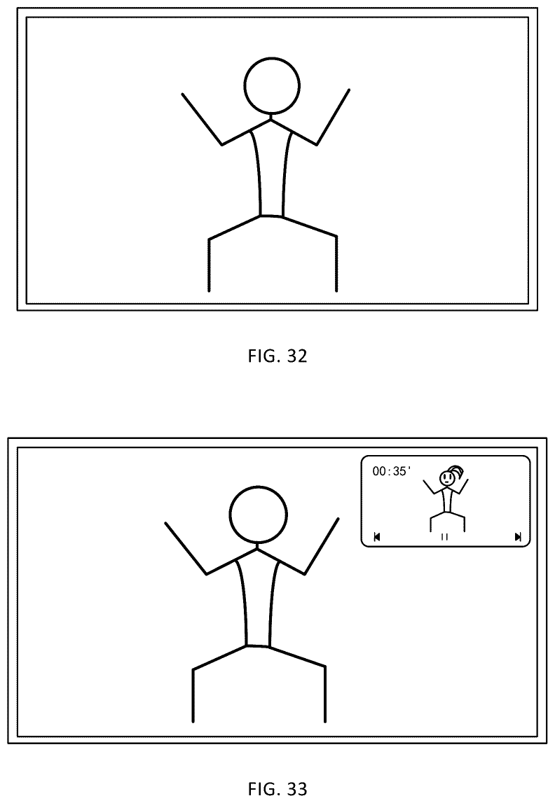

For example, the first application can be a fitness mirror application. Based on that the display 260 of the display apparatus 200 is in a horizontal position, the user can control the display apparatus 200 through the remote controller to start the fitness mirror application. The display apparatus 200 can respond to the key operation of the remote controller and displays the screen shown in FIG. 32 through the display 260.

After the first application is started, in order to realize the same-screen display of the applications, the second application can also need to be started in the display apparatus 200. Therefore, in some embodiments, the display apparatus 200 can also obtain the image size and the global screen direction of the second application in response to the startup instruction for displaying the second application image. A floating window is set on the upper layer of the first application according to the image size and the global screen direction, and then the display 260 can be controlled to display the user interface of the second application through the floating window.

For example, the first application can be a fitness mirror application, and the second application can be a screen-mirroring cast application. The display apparatus 200 is in a horizontal state and the fitness mirror application has been started, and the screen displayed on the display 260 is shown in FIG. 32. The user can start the screen-mirroring cast application in the display apparatus 200 through the remote controller, and the display apparatus 200 can set the floating window of the screen-mirroring cast application according to the vertical screen direction and the image size of the screen-mirroring cast application, and display the screen shown in FIG. 33 through the display 260.

In order to facilitate obtaining the image size of the second application, in some embodiments, the display apparatus 200 can obtain the media data of the second application and extract the screen frame image in the media data. The image height and the image width can be parsed from the screen frame image to obtain the image size of the second application.

For example, take the second application as a screen-mirroring cast application. The display apparatus 200 can obtain the video stream sent by the screen-mirroring cast application, extract a frame of image from the video stream, detect the width and height of the image, and generate width data and height data. The display apparatus 200 can obtain the image size of the screen-mirroring cast application based on the width data and the height data.

Furthermore, since the media data in the second application can be of different size ratios, in order to set a floating window of an appropriate size, in some embodiments, the display apparatus 200, when setting the floating window on the upper layer of the first application according to the image size and the global screen direction, the screen width and screen height of the image size can be parsed, and the image ratio of the second application can be calculated based on the screen width and screen height. If the screen width is greater than or equal to the screen height, the window size is set to a default width, and the window height can be calculated according to the ratio of the default width to the screen; if the screen width is less than the screen height, the window size can be set to a default height, and the window height can be calculated according to the ratio of the default width to the screen. That is, when setting the floating window of the second application, the display apparatus 200 can scale the user image of the second application according to the image ratio of the second application and the preset default value.

For example, taking the second application as a screen-mirroring cast application, the media data of the screen-mirroring cast application, that is, the video stream of the screen-mirroring cast application can be obtained. The width of the video stream is recorded as VideoWidth, and the height of the video stream is recorded as VideoHeight. When setting a floating window on the upper layer of the first application, the display apparatus 200 can obtain the width and height of the current parent layout, records the width of the parent layout as ViewWidth, and records the height of the parent layout as ViewHeight. And the width and height of the floating window can be calculated as follows.

If VideoWidth≥VideoHeight, the width of the parent layout can be determined to be fixed, recorded as X, then the height of the parent layout is X*VideoHeight/VideoWidth, and the width and height of the floating window are the same as the width and height of the parent layout. If VideoWidth<VideoHeight, the height of the parent layout can be determined to be fixed, recorded as Y, then the height of the parent layout is Y*VideoWidth/VideoHeight, and the width and height of the floating window are the same as the width and height of the parent layout. The display apparatus 200 can set a floating window according to the set width and height dimensions to display the user screen of the screen-mirroring cast application through the floating window.

In addition, since the second application is displayed on the upper layer of the first application through a floating window, the floating display state is a special display state. Therefore, based on that the display apparatus 200 displays an application in a floating state, the display apparatus 200 can display the user interface of the application through a floating window only after the underlying application enters a state supporting floating and is ready.

Therefore, in some embodiments, based on that the display apparatus 200 starts the second application, it can obtain the preparation state of the first application. If the preparation state is a state of preparation completed, as shown in FIG. 33, the display apparatus 200 can control the display 260 to display the second application in a floating manner on upper of the first application, so that the display apparatus 200 can display user interfaces of multiple applications on the same screen. If the preparation state is an unprepared state, the display apparatus 200 can control the display 260 to display the second application in full screen, so that the user can view the user interface of the second application on a large screen.

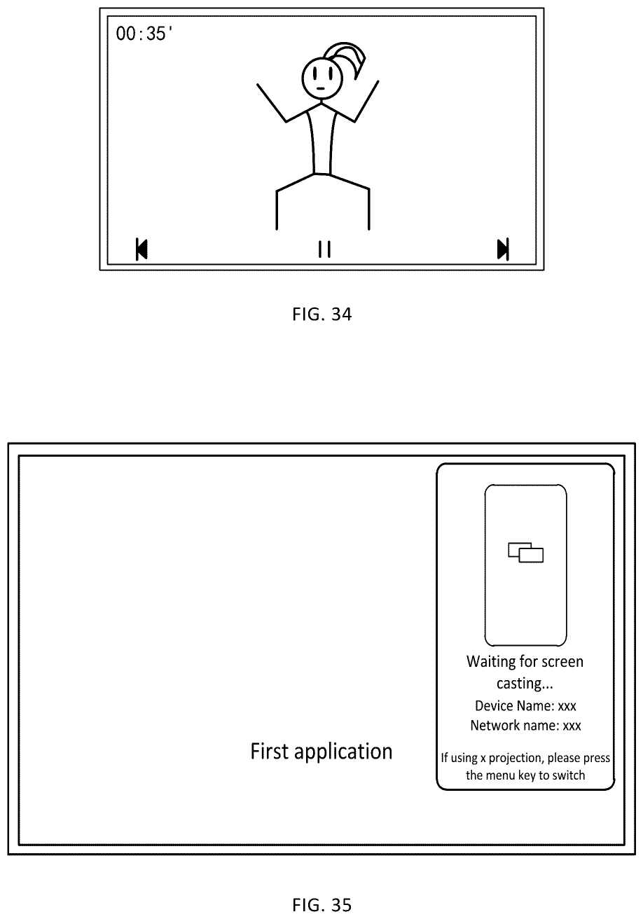

For example, the display apparatus 200 is displaying the user interface of the first application. At this time, the user can send a startup instruction to display the second application screen to the display apparatus 200. The display apparatus 200 can detect the preparation state of the first application, and detect that the first application is not fully prepared. If the first application is in an unprepared state, it means that the current state does not support displaying the user interfaces of the first application and the second application on the display apparatus 200 at the same time. Then, the display apparatus 200 can control the display 260 to display the image shown in FIG. 34 in full screen for the user to watch.

Furthermore, in order to facilitate the display apparatus 200 to obtain the state of the first application, in some embodiments, the display apparatus 200 can receive a state message of the first application, and parse an identifier contained in the state message to determine the preparation state of the current application.

For example, the preparation state identifier of the first application can include IDLE-preparation in progress, PREPARE-preparation completed, FOCUS-preparation completed, FINISH-interface exit, and ERROR-abnormal. The display apparatus 200 can parse the identifier included in the state message, and then determine the preparation state of the application. When the preparation state of the first application is PREPARE-preparation completed or FOCUS-preparation completed, it means that the first application is ready and can be floated. At this time, the display apparatus 200 can control the display 260 to display the second application in a floating manner above the first application.

In some embodiments, the display apparatus 200 can also set a corresponding identifier to indicate the preparation state of the first application according to the type of the first application. Since background service applications themselves can be configured with background running and floating functions, if the first application is a background service application, such as a screen-mirroring cast application that relies on wireless network communication technology, the first application can be directly represented as being in a preparation state through an identifier. If the first application is not a background service application and needs a startup interface to be started, it is necessary to control the floating function switch and use the floating function switch to indicate that the first application is ready.

For example, a background service application can use the PREPARED state to represent the preparation completed state; a non-background service application can control its function switch through FOCUS, and notify the current application through FOCUS that it can support the floating interface display.

For applications that can only be started on the startup interface, the display apparatus 200 can require the user to perform corresponding operations on the startup interface before floating the user interface of the application to complete the startup. Therefore, in some embodiments, if the second application is a non-background service application, the display apparatus 200 can control the display 260 to display an operation prompt interface when the second application is started. After the display 260 displays the operation prompt interface, the display apparatus 200 can monitor the startup state of the second application. If the second application is started, the display 260 can be controlled to close the operation prompt interface.

To facilitate users in viewing the operation prompt interface, in some embodiments, based on that the display 260 is in a horizontal state, the display apparatus 200 can display the operation prompt interface in a display position on the right side of the display 260 according to a fixed-size layout; based on that the display 260 is in a vertical state, the display apparatus 200 can display the operation prompt interface in a display position in the upper right corner of the display 260 according to a fixed-size layout, so as to clearly present the operation prompt interface on the display 260, making it convenient for users to operate according to the prompt information.

Furthermore, based on that the display apparatus 200 displays the operation prompt interface, the user can also input an operation instruction to the display apparatus 200 to change the corresponding operation prompt interface to select a startup method for the application. That is, in some embodiments, the display apparatus 200 can receive an operation instruction input by the user for changing the operation interface, and change the corresponding operation prompt interface in response to the operation instruction to switch the startup mode.

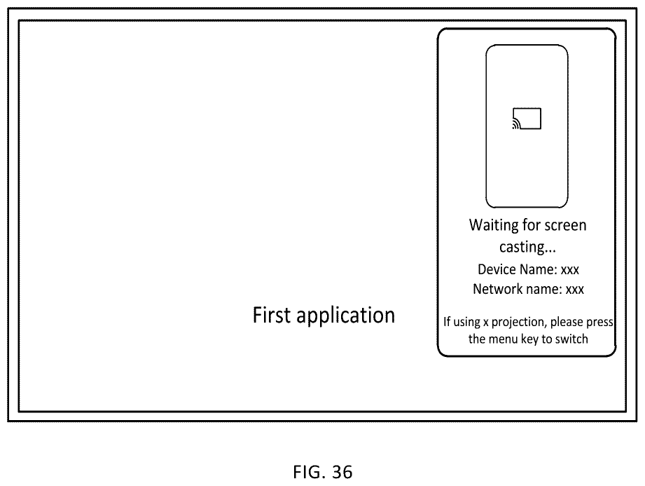

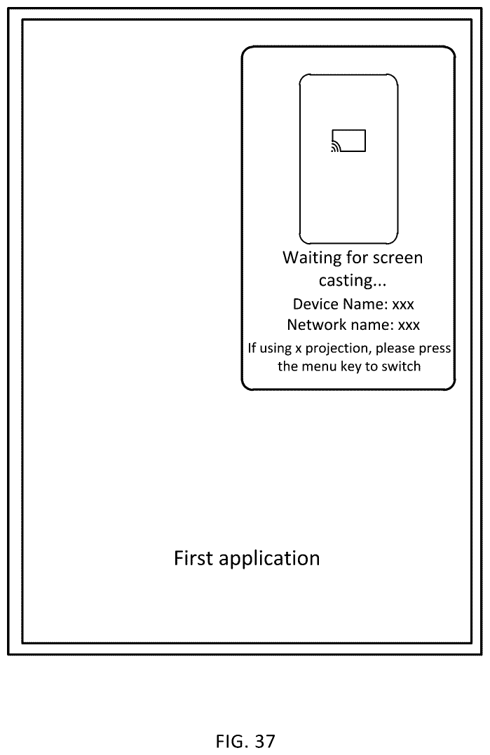

For example, it is assumed that the second application is a screen-mirroring cast application and the display 260 is in a horizontal state. After the user starts the screen-mirroring function in the display apparatus 200, the display apparatus 200 can display an operation prompt interface for the screen-mirroring cast connection as shown in FIG. 35. After the user clicks a designated button on the remote controller, the display apparatus 200 can respond to the user's operation and switch to an operation prompt interface as shown in FIG. 36 in the display 260. At this time, the user can adjust the display 260 to the vertical state through the rotating component 280, and the display apparatus 200 can display the operation prompt interface shown in FIG. 37. The user can perform corresponding operations on the screen-mirroring device synchronously according to the operation prompt interface to establish a screen-mirroring relationship with the display apparatus 200. Furthermore, after the screen-mirroring device establishes a screen-mirroring cast connection relationship with the display apparatus 200, the display apparatus 200 can close the operation prompt interface.

It can be understood that the first application and the second application in the embodiments of the present application are applications that establish a data intercommunication relationship with each other and both support floating display.

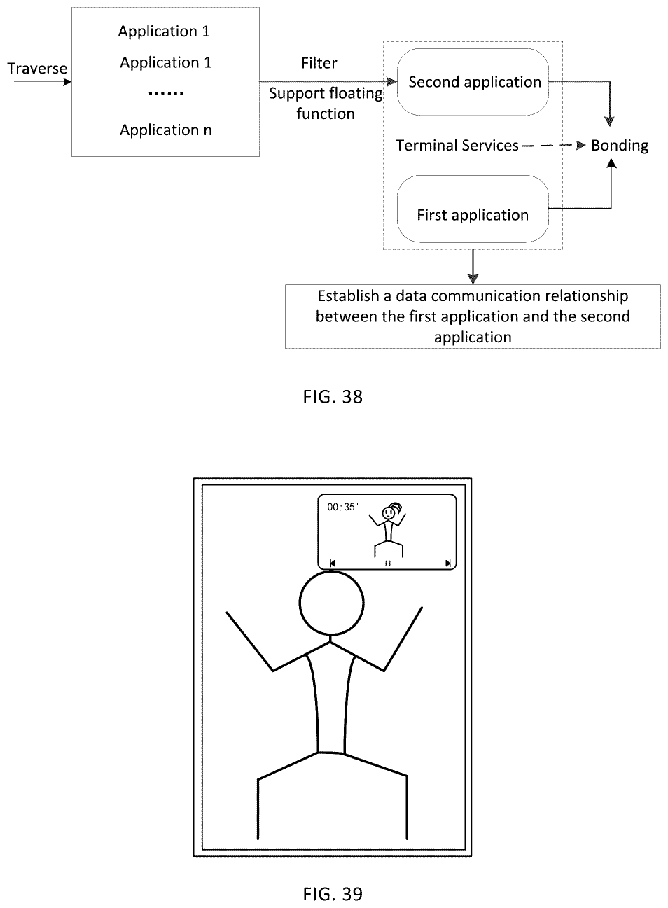

Therefore, in order to establish a data intercommunication relationship between the first application and the second application, in some embodiments, the display apparatus 200 can traverse the applications in the display apparatus 200 and select applications that support the floating function to serve as the first application or the second application. The client services in the first application and the second application can be bonded to establish a data intercommunication relationship between the first application and the second application. That is, as shown in FIG. 38, the display apparatus 200 can traverse all the applications that it has deployed, and select the applications that support the floating function from all the applications. After the applications supporting the floating function are selected, the client services between the applications can be bonded, so that a data intercommunication relationship between the first application and the second application can be established, so that the first application and the second application can perform data communication.

For example, the first application can be a background service application. After the second application is started, the display apparatus 200 can traverse the current whole applications through the metadata information to determine whether there is an application that supports floating. If there are applications that support floating, the agreed client services can be bonded in sequence, thereby completing the data intercommunication between the applications that support floating in the display apparatus 200. The state information of the first application can be received, and it is parsed that the preparation state of the first application is PREPARE. As shown in FIG. 33, the display apparatus 200 can display the user interface of the second application in a floating window on the upper layer of the first application.

It can be seen from the above embodiments that after the first application and the second application are started, the display apparatus 200 is in an image state as shown in FIG. 33, where the first application can be displayed in full screen and the second application can be displayed in a floating window. At this time, when the rotation event of the rotating component 280 is detected, the display apparatus 200 can immediately switch the display screen direction of the first application and reset the floating window of the second application.

S292: generate layout information according to the converted display screen direction and window size of the first application.

When the display apparatus 200 resets the floating window of the second application, it is necessary to obtain the screen direction after the first application is converted to determine the display direction of the display 260 after the rotation component 280 is rotated. Furthermore, since a floating window of the second application can already exist in the current display interface of the display 260, it is necessary to re-determine the layout information of the floating window in combination with the size of the currently displayed floating window.

S293: set a floating window on the upper layer of the first application according to the layout information and the image size, and control the display to display the user interface of the second application through the floating window.

After determining the layout information of the floating window, the display apparatus 200 can calculate the size of the floating window according to the layout information and the image size to set the floating window. After the floating window is set, the user interface of the second application can be displayed on the upper layer of the first application through the floating window, so that when the display apparatus 200 is rotated, multiple user interfaces can be quickly and dynamically adjusted.

In some embodiments, the layout information can include a preset display position, a default width, and a default height. The display apparatus 200 can also obtain a display position according to the global screen direction, and display the user interface of the second application on the display position through the floating window. For example, when the screen is in vertical direction, the floating window can be displayed in the right area; when the screen is in horizontal direction, the floating window can be displayed in the upper right corner area, etc. The default height and the default width are both fixed values preset in the display apparatus 200 to facilitate determining the size and display position of the floating window.

In some embodiments, when the display apparatus 200 sets a floating window on the upper layer of the first application according to the layout information and the image size, it can also parse the window width and window height of the window size, and calculate the screen ratio of the second application according to the image size. If the window width is greater than or equal to the window height, the window height can be obtained, and the width and height of the floating window can be calculated according to the ratio of the window height to the screen; if the window width is less than the window height, the window width can be obtained, and the width and height of the floating window can be calculated according to the ratio of the window width to the image.

For example: obtaining the media data of the second application, that is, the video stream in the second application. The width of the video stream is recorded as VideoWidth, and the height of the video stream is recorded as VideoHeight. When setting a floating window on the upper layer of the first application, the width and height of the current parent layout can be obtained, the width of the parent layout is recorded as ViewWidth, and the height of the parent layout is recorded as ViewHeight. When the display screen direction of the display 260 changes, the width and height of the floating window can be calculated as follows.

If ViewWidth≥ViewHeight, and the video stream VideoWidth≥VideoHeight, the width of the parent layout can be determined to be fixed, recorded as X, and the height is X*VideoHeight/VideoWidth, and the width and height of the floating window are the same as the width and height of the parent layout. If ViewWidth≥ViewHeight, and the video stream VideoWidth<VideoHeight, the width of the parent layout can be determined to be fixed, recorded as X, and the height is X*VideoWidth/VideoHeight, the width of the floating window is X*VideoWidth*VideoWidth/VideoWidth/VideoHeight, and the height of the floating window is X*VideoWidth/VideoHeight.

If ViewWidth<ViewHeight and the video stream VideoWidth≥VideoHeight, the height of the parent layout can be determined to be fixed, recorded as Y, then the width of the parent layout is Y*VideoHeight/VideoWidth, the width of the floating window is Y*VideoHeight/VideoWidth, and the height of is the floating window Y*VideoHeight*VideoHeight/VideoWidth/VideoWidth. If ViewWidth<ViewHeight and the video stream VideoWidth<VideoHeight, the height of the parent layout can be determined to be fixed, recorded as Y, then the height of the parent layout is Y*VideoWidth/VideoHeight, and the width and height of the floating window are the same as the width and height of the parent layout.

The above calculation method is applicable to the display 260 changing from horizontal to vertical and from vertical to horizontal. After setting the floating window of the second application, the display apparatus 200 can set the floating window according to the set size to display the user interface of the second application through the floating window.

For example, the first application can be a fitness mirror application, and the second application can be a screen-mirroring cast application. When the display 260 of the display apparatus 200 is in horizontal mode, a screen as shown in FIG. 33 can be displayed. At this time, the user can adjust the display 260 to a vertical state, and the display apparatus 200 can change the display screen direction of the fitness mirror application and reset the floating window of the screen-mirroring cast application to display the screen-mirroring cast application through the floating window. That is, after the display 260 is switched to the vertical state, the screen shown in FIG. 39 can be displayed.

In addition, to ensure the user's viewing experience, some applications may only support one display screen direction. For example, the image ratio of the media data in the first application is horizontal. If it is played in vertical mode, the displayed image will be too small or incomplete. Therefore, in some embodiments, the display apparatus 200 can further detect a configured screen direction of the first application, where the configured screen direction is a display screen direction supported by the first application. If the global screen direction is not within the range of the configured screen direction, the floating windows can be traversed, and a target application can be selected according to a preset priority, the target application being the second application that supports the global screen direction. The levels of the first application and the target application are switched to display the target application in full screen. A floating window of the first application can be set on an upper layer of the target application, and a user interface of the first application can be displayed through the floating window. Then, when the user rotates the display 260, the display apparatus 200 can automatically display the first application and the second application according to the optimal display layout.

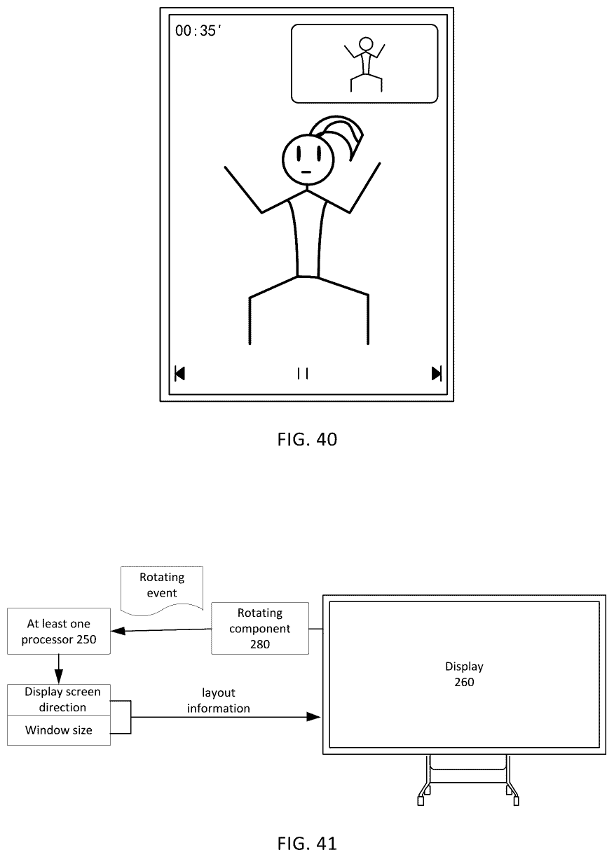

For example, the first application can be a fitness mirror application, and the second application can be a screen-mirroring cast application. The configuration screen direction of the fitness mirror application is horizontal, and the configuration screen direction of the screen-mirroring cast application is vertical. As shown in FIG. 33, the display apparatus 200 is playing the fitness mirror application and the screen-mirroring cast application in a horizontal state. At this time, the user can rotate the display apparatus 200 to a vertical state. Since the fitness mirror application does not support vertical screen display, as shown in FIG. 40, the display apparatus 200 can switch the levels of the fitness mirror application and the screen-mirroring cast application, display the screen-mirroring cast application in full screen and display the fitness mirror application in floating.

In some embodiments, the preset priority rule can be set according to the image ratio of the second application, and a second application that is closer to the ratio of the display 260 is set with a higher weight, and a second application that is currently in a vertical state is set with a higher weight. The second application with the highest accumulated weight value can be marked as the target application, so as to screen out a unique target application from the second applications corresponding to the floating window and switch the display level with the first application.

It is understandable that if the level of the first application in the display apparatus 200 is exchanged, the display apparatus 200 can reset the floating window of the first application. Among them, the method of setting the first application floating window is the same as the method of setting the second application floating window, which will not be repeated here.

In addition, in order to facilitate the user to interact with the display apparatus 200, in some embodiments, the display apparatus 200 can also obtain various control instructions input by the user, respond to the control instructions, and perform corresponding operations. The switching instruction can be issued by the terminal device 300, such as a mobile phone, etc.; it can also be issued by a remote controller provided with the display apparatus 200; or it can be issued by an external touch component of the display apparatus 200. That is, the first application and the second application can respond to corresponding operations according to the control instruction.

In order to facilitate the first application and the second application to execute the control instruction, in some embodiments, the display apparatus 200 can monitor the focus event of the second application, encapsulate the focus event into a control instruction corresponding to the event, and control the second application to send the control instruction to the first application. Then, the first application can be controlled to forward the control instruction to other applications to notify other applications to execute the control instruction, where the other applications are applications other than the first application and the second application in the display apparatus.

That is, since the first application and the second application are in a data intercommunication relationship, the display apparatus 200 can always capture the focus event through the topmost application. After capturing the focus event of the switching screen position, the focus event is forwarded to the lower layer application. After receiving the focus event, the lower layer application can notify the upper-layer application to perform the operation corresponding to the focus event.

Furthermore, in some embodiments, after detecting a focus event, the display apparatus 200 can further parse the focus event. And according to the analysis result, the focus event can be encapsulated as a control instruction corresponding to the event. For example, an event for rotating the horizontal or vertical screen image is encapsulated as a rotation instruction. The display apparatus 200 can parse the application targeted by the control instruction, execute the control instruction through the first application, and/or control the first application to forward the control instruction to the second application so that the application corresponding to the control instruction can perform the corresponding operation.

For example, the first application can be a fitness mirror application, and the second application can be a screen-mirroring cast application. Firstly, the user can start the fitness mirror application in the display apparatus 200, and the fitness mirror application can start an activity, capture the focus event, and bond to the client service for communication. Then, after the display apparatus 200 receives the screen-mirroring message, the screen-mirroring cast application can start an activity and capture the focus event. At this time, the fitness mirror application can no longer capture focus events, and change to capturing focus events through the screen-mirroring cast application. After the screen-mirroring cast application captures the focus event, it can forward or execute the relevant focus event through the activity of the fitness mirror application, and notify other intermediate applications to perform UI switching.

In addition, in some embodiments, the user can send a switching instruction to the display apparatus 200 through a control device such as a remote controller to switch the display screen direction of the second application. The display apparatus 200 can detect the window size of the second application in response to the switching instruction. If the window width of the second application is greater than or equal to the window height, the window height can be obtained, and the window can be displayed according to the window height and the image size; if the window width of the second application is less than the window height, the window width can be obtained, and the window can be displayed according to the window width and the image size.

For example, still taking the second application as a screen-mirroring cast application, the display apparatus 200 can obtain the media data of the second application, that is, the video stream of the second application. The width of the video stream is recorded as VideoWidth, and the height of the video stream is recorded as VideoHeight. The placement state of the screen-mirroring device has changed, so the displayed image state has also changed. When the image state of the screen-mirroring cast application is detected to have changed, the width and height of the current parent layout can be obtained, and the width of the parent layout is recorded as ViewWidth, and the height of the parent layout is recorded as ViewHeight. The width and height of the window can be calculated as follows.

If ViewWidth≥ViewHeight, and VideoWidth≥VideoHeight, the height of the parent layout can be determined to be a fixed height, recorded as Y, then the width of the parent layout is Y*VideoHeight/VideoWidth, the width of the floating window is Y*VideoHeight/VideoWidth, and the height of the floating window is Y*VideoHeight*VideoHeight/VideoWidth/VideoWidth. If ViewWidth≥ViewHeight, and VideoWidth<VideoHeight, the height of the parent layout can be determined to be a fixed height, recorded as Y, then the height of the parent layout is Y*VideoWidth/VideoHeight, and the width and height of the window are the same as the width and height of the parent layout.

If ViewWidth<ViewHeight, and VideoWidth≥VideoHeight, the width of the parent layout can be determined to be fixed width, recorded as X, then the height of the parent layout is X*VideoHeight/VideoWidth, and the width and height of the floating window are the same as the width and height of the parent layout. If ViewWidth<ViewHeight, and VideoWidth<VideoHeight, the width of the parent layout can be determined to be fixed width, recorded as X, then the height of the parent layout is X*VideoWidth/VideoHeight, the width of SurfaceView is X*VideoWidth*VideoWidth/VideoHeight/VideoHeight, and the height of the window is X*VideoWidth/VideoHeight. After resetting the floating window of the second application, the display apparatus 200 can set the floating window according to the set size to display the user interface of the second application through the floating window.

In some embodiments, while applications are displayed on the same screen, the user can also close any application at any time to close its corresponding display window. That is, the display apparatus 200 can receive the close instruction and send the close instruction to the first application. Then, the close instruction can be executed by the first application, and/or the first application can be controlled to forward the close instruction to the second application, so as to control the second application to execute the close instruction.

Obviously, after the application is closed, the display 260 will no longer display the user interface of the application. Then, if the user closes the first application, the display 260 can only display the user interface of the second application. Since the second application is in a floating display state, if only the first application is closed, the display 260 can still display the second application through a floating window, which will cause most of the display area in the display 260 to be wasted, thereby reducing the user experience.

Therefore, in some embodiments, the display apparatus 200 can detect the close states of the first application and the second application. If the first application is in a close state and the second application is not in a close state, the display 260 can be controlled to display the user interface of the second application in full screen.

For example, the first application can be a fitness mirror application, and the second application can be a screen-mirroring cast application. When the display apparatus 200 displays the user interface shown in FIG. 33, if the user closes the fitness mirror application of the display apparatus 200, the display apparatus 200 can immediately destroy the display window of the fitness mirror application and exit the display screen of the fitness mirror application. At the same time, as shown in FIG. 34, the display apparatus 200 can display the user interface of the screen-mirroring cast application in full screen.

It is understandable that the close instruction is not limited to the user input method, and the application can be closed due to other reasons, such as network disconnection, conflict disconnection, etc. Therefore, in some embodiments, after detecting that the connection between the application and the display apparatus 200 is abnormal, the display apparatus 200 can automatically generate a close instruction so that the display apparatus 200 can close the application.

For the case where the application is not closed actively by the user, in order to facilitate the user to understand the reason for closing the application, in some embodiments, the close instruction can carry the reason for closing the application. When encapsulating the close instruction, the display apparatus 200 can encapsulate the close reason into the close instruction. In this way, when executing the close instruction, the display apparatus 200 can also analyze the close reason and control the display 260 to display corresponding prompt information according to the close reason.

For example, the first application can still be a fitness mirror application, and the second application can be a screen-mirroring cast application. When the display apparatus 200 displays the user interface shown in FIG. 33, it can receive a close instruction of the screen-mirroring cast application due to network reasons. The display apparatus 200 can parse the close reason from the close instruction, and notify other applications of the display apparatus 200 of the close reason and the close instruction through the underlying screen-mirroring cast application, so that the display apparatus 200 can display a prompt message “Network connection abnormality, screen-mirroring cast connection disconnected” in the display 260 according to the close reason.

Based on the third processing method for a display apparatus, a display apparatus 200 in some embodiments of the present application, as shown in FIG. 41, can include: a display 260, a rotating component 280 and at least one processor 250. The display 260 can be configured to display the user interface of the first application, and to display the user interface of the second application in a floating window on the upper layer of the first application. The rotating component 280 can be configured to rotate the display 260. As shown in FIG. 18, at least one processor 250 can be configured to execute computer instructions stored in a memory of the display apparatus to cause the display apparatus 200 to perform the following operations.

S291: in response to a rotation event of the rotating component, convert the display screen direction of the first application, and obtain the window size and image size of the second application; where the first application and the second application are applications that establish a data intercommunication relationship with each other and both support floating display.

S292: generate layout information according to the display screen direction and window size after conversion of the first application.

S293: set a floating window on the upper layer of the first application according to the layout information and the image size, and control the display to display the user interface of the second application through the floating window.

It can be seen from the above technical solutions that the display apparatus according to some embodiments of the present application and the third processing method for the display apparatus can respond to the rotation event of the rotating component, convert the display screen direction of the first application, and obtain the window size and image size of the second application. The first application and the second application are applications that establish a data intercommunication relationship with each other and both support floating display. The method can generate layout information of the floating window according to the display screen direction and window size after the first application is converted. Then, a floating window can be set on the upper layer of the first application according to the layout information and the image size of the second application. After setting the floating window, the display 260 can be controlled to display the user interface of the second application through the floating window, so that when the display apparatus 200 rotates, the user interface of the application can be quickly adjusted to improve the user experience.

It can be seen from the foregoing content that in some embodiments, for a display apparatus 200 having the same or similar software and hardware configuration as the foregoing device, the terminal device 300 (screen-mirroring sending end) can push media data to the display apparatus 200 (screen-mirroring receiving end), and the media data include but are not limited to video, image, audio, text and other types.

In some embodiments, the user can use certain applications with screen-mirroring function in the terminal device 300 to project the media data of interest to the display apparatus 200 for large-screen playback. Alternatively, the terminal device 300 and the display apparatus 200 can establish a screen-mirroring cast connection through certain protocols, such as the DLNA (Digital Living Network Alliance) protocol. Alternatively, the terminal device 300 can perform mirror screen cast with the display apparatus 200. For example, the current screen content of the terminal device 300 can be synchronized to the display apparatus 200 through wireless screen-mirroring methods such as Miracast and Airplay, thereby realizing screen sharing and multi-screen interaction.

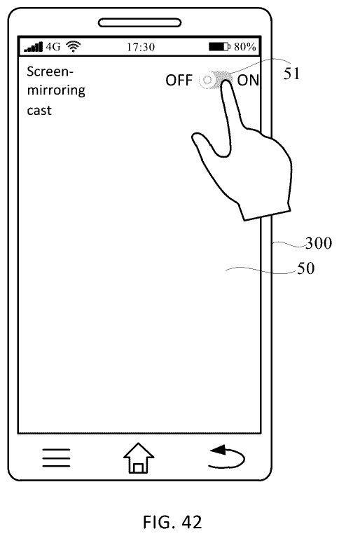

In one implementation, before the terminal device 300 initiates a screen-mirroring cast instruction to the display apparatus 200, the terminal device 300 and the display apparatus 200 can be connected with the same local area network (eg, WiFi). Taking mirror screen cast as an example, FIG. 42 is a screen-mirroring setting interface 50 displayed by the terminal device 300 according to some embodiments of the present application, and the screen-mirroring setting interface 50 can include a screen-mirroring switch 51. As shown in FIG. 42, the user can set the on/off state of the screen-mirroring switch 51 by touch operation according to usage requirements.

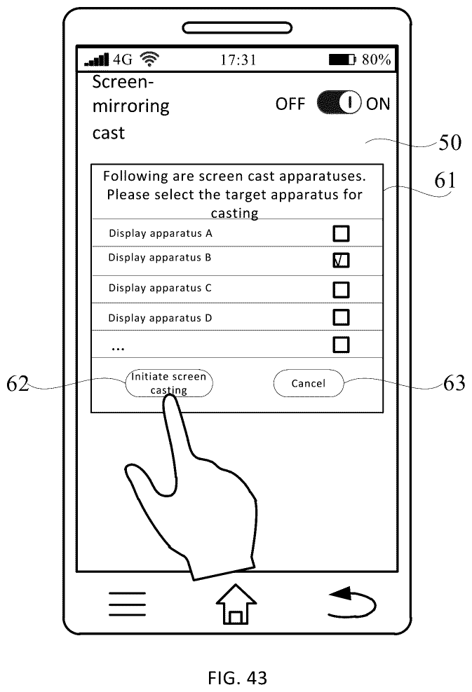

In response to the user's operation of turning on the screen-mirroring switch 51, the terminal device 300 can control the display screen to switch the screen-mirroring switch 51 in the screen-mirroring setting interface 50 to the on state, as shown in FIG. 43, and search for a screen-mirroring device that can establish a screen-mirroring cast connection with the terminal device 300, and control the display screen to display a screen-mirroring device list 61, an initiate screen-mirroring button 62, and a cancel button 63 in the screen-mirroring setting interface 50. Among them, the screen-mirroring device list 61 can include N screen-mirroring devices, and the screen-mirroring devices can be display apparatuses that are connected with the same local area network as the terminal device 300 and support the screen-mirroring function, where N is greater than or equal to 0.

If N is equal to 0, that is, there is currently no screen-mirroring device, and the user can refresh the screen-mirroring setting interface 50 or the list of screen-mirroring devices 61. If N is greater than 0, the user can select a target device from the list of devices that support screen-mirroring, and click the initiate screen-mirroring button 62.

In response to the user clicking the initiate screen-mirroring button 62, the terminal device 300 can obtain the device information of the target device and send a screen-mirroring request to the target device. The screen-mirroring request can carry device information of the terminal device 300, including but not limited to the device name or model, MAC address, etc.

In response to the user clicking the cancel button 63, the terminal device 300 can close the screen-mirroring device list 61, or can switch the screen-mirroring switch 51 to an off state. In this scenario, the terminal device 300 cannot initiate a screen-mirroring cast instruction to any display apparatus.

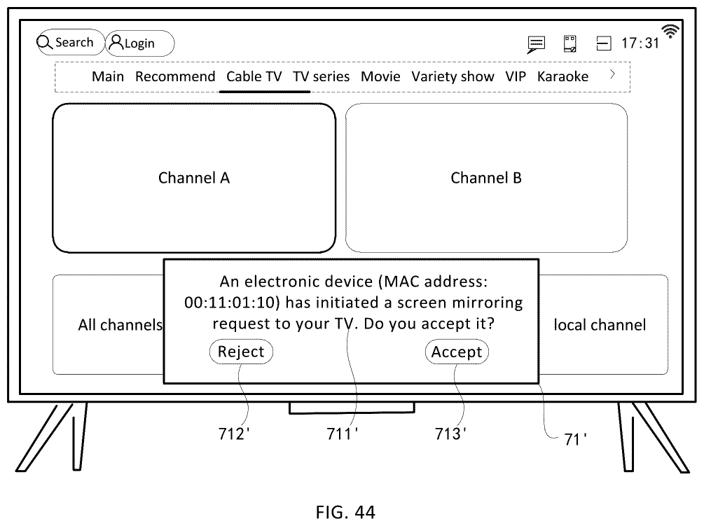

FIG. 44 is a screen-mirroring request interface displayed by the display apparatus 200 according to some embodiments of the present application. After the display apparatus 200 (i.e., the target device) receives the screen-mirroring request, as shown in FIG. 44, it can control the display 260 to display the screen-mirroring request interface 71′, which can include a prompt message 711′, a reject button 712′ and an accept button 713′.

Among them, the prompt information 711′ can include the device information of the terminal device 300, which can be used to prompt that the terminal device 300 has initiated a screen-mirroring cast instruction to the local device and ask the user whether to accept the screen-mirroring cast instruction.

The display apparatus 200 can receive an operation input by a user through the control device 100 (for example, a remote controller). If the display apparatus 200 can receive a click operation on the reject button 712′ from the user, it cannot establish a screen-mirroring cast connection with the terminal device 300 and can send a screen-mirroring rejection message to the terminal device 300. When the terminal device 300 receives the screen-mirroring rejection information, it can prompt the display apparatus 200 that the screen-mirroring request has been rejected.

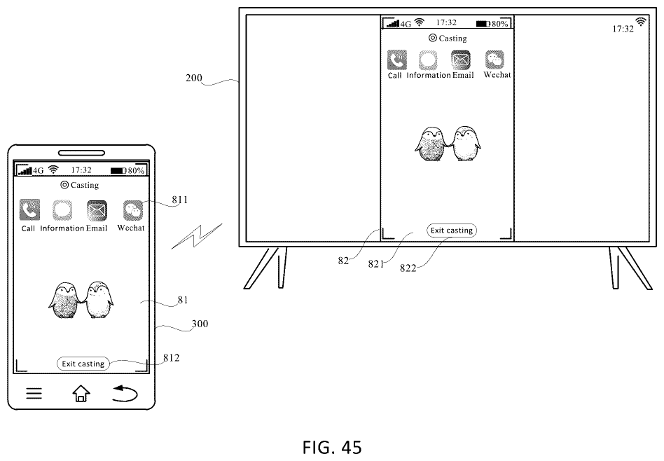

If the display apparatus 200 can receive a click operation on the acceptance button 713′ by the user, it can establish a screen-mirroring cast connection with the terminal device 300. FIG. 45 is a display interface of the display apparatus 200 and the terminal device 300 after the screen-mirroring cast connection is successful according to some embodiments of the present application. As shown in FIG. 45, after the screen-mirroring cast connection is successful, the terminal device 300 can display a first screen-mirroring interface 81, which may include screen content 811 and a first screen-mirroring ending button 812.

After the screen-mirroring cast connection is successful, the terminal device 300 can start the screen recording program to record the current screen content of the local device to obtain the screen-mirroring cast data, and based on the screen-mirroring cast connection, synchronize the screen-mirroring cast data to the display apparatus 200 in the form of video stream transmission. In this way, after the display apparatus 200 receives the screen-mirroring cast data, as shown in FIG. 45, it can control the display 260 to display the second screen-mirroring interface 82. The second screen-mirroring interface 82 can include video content 821 corresponding to the screen-mirroring cast data and a second screen-mirroring ending button 822.

In response to the user clicking the first screen-mirroring ending button 812, the terminal device 300 can control the display screen to exit the first screen-mirroring interface 81, close executing the screen recording program (so that the video stream corresponding to the screen-mirroring cast data can be terminated), disconnect the screen-mirroring cast connection with the display apparatus 200, and send the first screen-mirroring ending information to the display apparatus 200. The display apparatus 200 can receive the first screen-mirroring end information, control the display 260 to exit the second screen-mirroring interface 82, and display the interface corresponding to the current signal source, thereby ending the current screen-mirroring normally.

In some embodiments, the user can also end the screen-mirroring operation on the display apparatus 200. In response to the user clicking the second screen-mirroring end button 822, the display apparatus 200 can control the display 260 to exit the second screen-mirroring interface 82, display the interface corresponding to the signal source before screen-mirroring, disconnect the screen-mirroring cast connection with the terminal device 300, and send a second screen-mirroring end information to the terminal device 300. The terminal device 300 can receive the second screen-mirroring end information, control the display screen to exit the first screen-mirroring interface 81, and close executing the screen recording program, thereby ending the screen-mirroring normally.

In some embodiments, when the display apparatus 200 is displaying the second screen-mirroring interface 82, if the display apparatus 200 receives an operation by the user to switch the signal source, for example, the user can switch the signal source to a signal channel such as ATV (Analog TV), DTV (Digital TV) or HDMI, the display apparatus can control the display 260 to exit the second screen-mirroring interface 82, display the interface corresponding to the switched target signal source, disconnect the screen-mirroring cast connection with the terminal device 300, and send a third screen-mirroring end information to the terminal device 300. The terminal device 300 can receive the third screen-mirroring end information, control the display screen to exit the first screen-mirroring interface 81, and close executing the screen recording program. In this implementation, if the user switches the signal source on the display apparatus 200, the current screen-mirroring can be forcibly ended.

In some embodiments, when the display apparatus 200 is displaying the second screen-mirroring interface 82, if the user receives an operation to switch the signal source, it can also continue to disconnect the screen-mirroring cast connection with the terminal device 300, continue to receive the screen-mirroring cast data transmitted by the terminal device 300, run the current screen-mirroring cast application in the background mode, and control the display 260 to display the interface corresponding to the switched target signal source in the foreground. In this way, when the display apparatus 200 receives the user's operation to switch back to the screen-mirroring cast application, for example, the user can click the return key on the control device 100, it can exit the target signal source and switch the screen-mirroring cast application from the background to the foreground, causing the display 260 to refresh and display the second screen-mirroring interface 82. In this implementation, if the user switches the signal source on the display apparatus 200, the screen-mirroring cast connection can be maintained and the screen-mirroring cast application can be switched from the foreground to the background without forcibly ending the current screen-mirroring.

After the display apparatus 200 receives the screen-mirroring cast data transmitted by the terminal device 300, it can control the display to display the screen-mirroring cast data in the second screen-mirroring interface 82 using the system default and fixed image quality parameters, where the image quality parameters can include but not limited to: brightness, contrast, color, clarity, white balance, sharpness, etc.

During the research process, the applicant found that factors such as the resolution of the screen-mirroring cast data and the processing capability of the display apparatus itself can affect the image quality and clarity presented by the second screen-mirroring interface 82, where the resolution can include the width and height of the video frame, such as 1920*1080.

In some embodiments, the screen-mirroring image quality adjustment logic executed by the display apparatus 200 is different depending on the screen-mirroring protocol, including but not limited to the following three situations.

The first situation: for some standard screen-mirroring protocols, the terminal device 300 can notify the display apparatus 200 of the resolution used for the screen-mirroring cast data after the display apparatus 200 accepts the screen-mirroring request. The resolution can be a fixed value. Even if the terminal device 300 detects a change in the screen direction during the screen-mirroring cast process, such as from a vertical screen to a horizontal screen, the display apparatus 200 cannot be notified of the change in resolution. In this way, the display apparatus 200 can display the screen-mirroring cast data according to the preset fixed resolution and the corresponding fixed image quality parameters. In this scenario, the display apparatus 200 cannot dynamically adjust the screen-mirroring image quality parameters.

The second situation: for some standard screen-mirroring protocols, the first resolution corresponding to the horizontal screen direction and the second resolution corresponding to the vertical screen direction can be preset. With respect to the screen-mirroring protocol and scenario, in some embodiments of the present application, after the display apparatus 200 accepts the screen-mirroring request, the terminal device 300 can detect the current screen direction. For example, if the current screen direction is horizontal, the display apparatus 200 can be notified that the resolution of the screen-mirroring cast data is the first resolution. In this way, the display apparatus can match the first image quality parameters according to the first resolution, and start displaying the screen-mirroring cast data according to the first image quality parameters. When the terminal device 300 detects that the screen direction switches to vertical, it can notify the display apparatus 200 that the resolution of the screen-mirroring cast data has changed to the second resolution, so that the display apparatus can match the second image quality parameters according to the second resolution and display the screen-mirroring cast data according to the second image quality parameters. In this scenario, the display apparatus 200 can dynamically adjust the image quality parameters of the screen-mirroring cast data based on that the screen direction of the terminal device 300 changes.

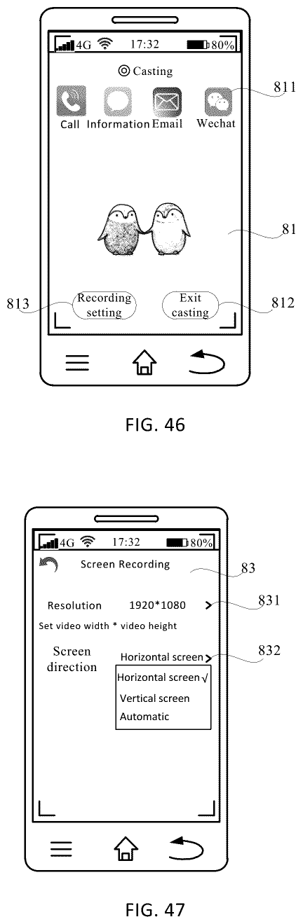

The third situation: this field can also formulate a screen-mirroring protocol corresponding to the screen-mirroring cast application based on the user's screen-mirroring needs, for example: a screen-mirroring protocol that can support the mirror screen cast sender (i.e., the terminal device 300) to perform screen recording settings, etc. FIG. 46 is a first screen-mirroring interface 81 displayed by another terminal device 300 according to some embodiments of the present application. As shown in FIG. 46, the first screen-mirroring interface 81 can further include a screen recording setting button 813. In response to the user clicking the screen recording setting button 813, the terminal device can control the display screen to display the screen recording setting interface.

FIG. 47 is a schematic diagram of the terminal device 300 displaying the screen recording setting interface 83 according to some embodiments of the present application. As shown in FIG. 47, the screen recording setting interface 83 can include, but is not limited to, a resolution setting button 831 and a screen direction setting button 832.

In response to the user clicking the resolution setting button 831, the terminal device 300 can display at least one resolution option, such as 1920*1080, 720*1280, etc., and can also include a custom option so that the user can customize the width and height of the video.

In response to the user clicking the screen direction setting button 832, the terminal device 300 can display screen direction options to adjust the direction of the recorded video. The screen direction options can include horizontal, vertical, and automatic. Among them, setting the screen to horizontal mode can make the aspect ratio of the recorded video greater than or equal to 1, and setting the screen to vertical mode can make the aspect ratio of the recorded video less than 1. The “Auto” option can be configured to automatically match the screen direction according to the resolution of the screen recording. For example, if the current screen recording resolution (video width*video height) is 608*1080, the screen direction can be automatically set to “Vertical”. Alternatively, the “Auto” option can also be configured so that the screen direction follows the terminal device 300. For example, if the screen direction of the terminal device 300 is currently vertical, if it is detected that the terminal device 300 is flipped 90 degrees, the screen direction can be automatically switched to horizontal.

Based on the resolution setting button 831 and/or the screen direction setting button 832 in the screen recording setting interface 83, the user can more flexibly and dynamically adjust the resolution of the screen-mirroring cast data on the terminal device 300, that is, the resolution of the screen-mirroring cast data can be changed dynamically. For the second and third situations mentioned above, if the display apparatus 200 displays the screen-mirroring cast data with the default fixed image quality parameters, it cannot dynamically adjust the image quality parameters as the resolution of the screen-mirroring cast data changes, resulting in the screen-mirroring content presented by the display apparatus 200 being not clear enough and the image quality being poor, affecting the user's screen-mirroring viewing experience.

To solve the problems described above, some embodiments of the present application provide an implementation scheme that can dynamically and adaptively adjust the image quality parameters used when displaying screen-mirroring cast data. The display apparatus 200 can preset and store the mapping relationship between the screen direction, preset resolution and image quality parameters according to the CPU chip configured locally.

In one implementation, assuming that the display apparatus 200 can be configured with a CPU1, in the horizontal screen mode, the CPU1 can adjust the image quality parameters based on the vertical resolution (i.e., video height) of the screen-mirroring cast data, and the preset mapping relationship can be the following relationships.

If the video height is greater than or equal to 1080, the image quality parameters can include but not limited to: brightness A1, contrast B1, chroma C1, clarity D1, etc.

If 1080>video height≥720, the image quality parameters include but not limited to: brightness A2, contrast B2, chroma C2, clarity D2, etc.

If 720>video height≥480, the image quality parameters include but not limited to: brightness A3, contrast B3, chroma C3, clarity D3, etc.

If the video height is less than 480, the image quality parameters include but not limited to: brightness A4, contrast B4, chroma C4, clarity D4, etc.

In one implementation, assuming that the display apparatus 200 can be configured with a CPU1, in the vertical mode, the CPU1 can adjust the image quality parameters based on the horizontal resolution (ie, video width) of the screen-mirroring cast data, and the preset mapping relationship can be the following relationships.

If the video width is greater than or equal to 1920, the image quality parameters can include but not limited to: brightness A5, contrast B5, chroma C5, clarity D5, etc.

If 1920>video width≥1280, the image quality parameters can include but not limited to: brightness A6, contrast B6, chroma C6, clarity D6, etc.

If 1280>video width≥1080, the image quality parameters can include but not limited to: brightness A7, contrast B7, chroma C7, clarity D7, etc.

If 1080>video width≥720, the image quality parameters can include but not limited to: brightness A8, contrast B8, chroma C8, clarity D8, etc.

If 720>video width≥480, the image quality parameters can include but not limited to: brightness A9, contrast B9, chroma C9, clarity D9, etc.

If the video width is less than 480, the image quality parameters can include but not limited to: brightness A10, contrast B10, chroma C10, clarity D10, etc.

For example, after the display apparatus 200 receives the screen-mirroring cast data, it can query that the resolution of the screen-mirroring cast data is 608*1080, which can be a vertical video stream, and the width 608 of the video stream is in the range of [480,720). Then, the display can be controlled to display the screen-mirroring content corresponding to the video stream according to the image quality parameters such as brightness A9, contrast B9, chroma C9, and clarity D9.

For another example, the resolution of the screen-mirroring cast data received by the display apparatus 200 is 1280*960, which can be a horizontal video stream, and the height 960 of the video stream is in the range of [720,1080). Then the display can be controlled to display the screen-mirroring content corresponding to the video stream according to the image quality parameters such as brightness A2, contrast B2, chroma C2, and clarity D2.

It should be noted that the mapping relationship provided above in the present application is merely an example and does not represent or limit the configuration of the actual mapping relationship. This field can set the interval distribution of preset resolutions according to application scenarios and user requirements. The preset resolution can fully cover the possible value range of the video width/height of the screen-mirroring cast data, and can also make the resolution interval finer, thereby improving the precision of image quality adjustment. In addition, more types of image quality parameters can be expanded to improve the screen-mirroring image quality of the display apparatus 200.

In some embodiments, the display apparatus 200 serving as the screen-mirroring receiving terminal can be configured with one or more CPU chips. Different CPU chip models have different processing capabilities, so that the display device 200 can present different image quality effects on the screen-mirroring cast data. If the display apparatus 200 has multiple CPU chips (i.e., a multi-core device), corresponding image quality parameter configuration information can be set for each CPU chip based on the processing capability of each CPU chip. The image quality parameter configuration information can include a mapping relationship between the CPU chip model, screen direction, preset resolution, and image quality parameters.

In some embodiments, for example, a dual-core display apparatus can include two CPU chips (CPU1 and CPU2), and corresponding image quality parameter configuration information can be set for CPU1 and CPU2 respectively. Assume that CPU1 can correspond to image quality parameter configuration information A and CPU2 can correspond to image quality parameter configuration information B. The embodiments of the present application cannot limit the number and model of processors.

In some embodiments, after the display apparatus 200 receives the screen-mirroring request initiated by the terminal device 300, it can receive information such as SPS (Sequence Parameter Set) sent by the terminal device 300. SPS can be an information set that records screen-mirroring related parameters, which can include image format information, encoding and decoding parameter information, time domain grading information, etc., among which the image format information can include the resolution of the video stream.

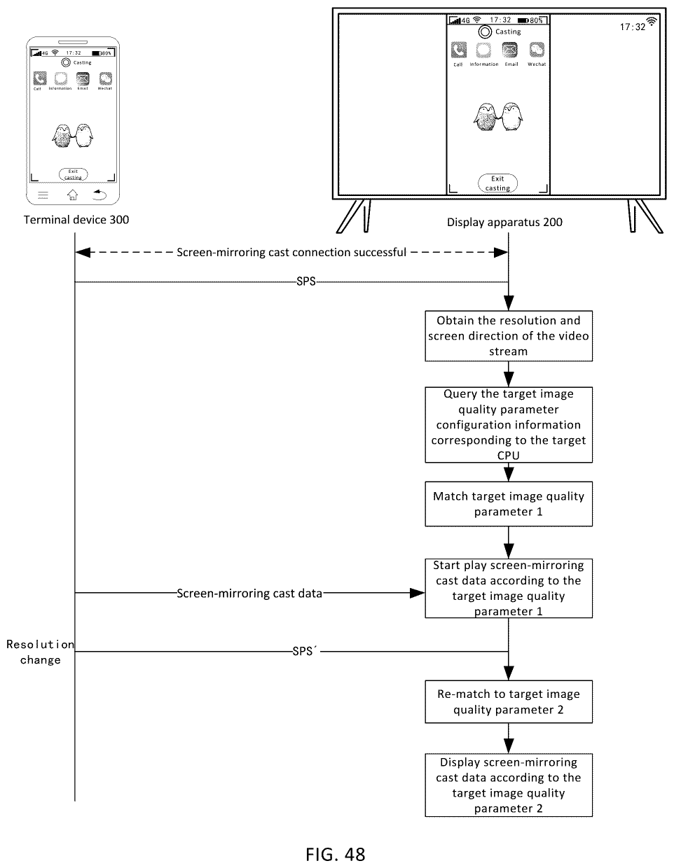

FIG. 48 is a schematic diagram showing a principle of dynamically adjusting image quality parameters of a display apparatus 200 according to some embodiments of the present application. As shown in FIG. 48, after the display apparatus 200 parses the SPS information sent by the terminal device 300, it can obtain the resolution of the video stream and the corresponding screen direction, query the target CPU currently processing the screen-mirroring cast process, and obtain the target image quality parameter configuration information corresponding to the target CPU. The display apparatus 200 can further obtain the matching target image quality parameter 1 from the target image quality parameter configuration information according to the screen direction and resolution of the video stream, receive the screen-mirroring cast data sent by the terminal device 300 in the form of a video stream after the SPS, and control the display to start playing the screen-mirroring cast data according to the target image quality parameter 1.

In some embodiments, the terminal device 300 can send SPS information to the display apparatus 200 in frames based on the recorded video stream, and carry the resolution of the current frame in the SPS information. In this way, the display apparatus 200 can obtain the resolution of each frame and autonomously detect whether the resolution of the video stream changes, thereby dynamically adjusting the image quality parameters.

In some embodiments, the terminal device 300 cannot send SPS information to the display apparatus 200 on a frame basis. Referring to FIG. 48, when the terminal device 300 detects that the resolution of the video stream has changed (for example, the user adjusts the resolution and/or screen direction of the screen recording), it can send an SPS′ to the display apparatus, where the SPS′ can include the updated resolution. After receiving the SPS′, the display apparatus can re-match the target image quality parameters 2 from the target image quality parameter configuration information according to the updated resolution and/or screen direction, and display the screen-mirroring cast data received after the SPS′ according to the target image quality parameters 2. Before the display apparatus 200 receives the SPS′, the resolution of the default screen-mirroring cast data can remain unchanged, so the display apparatus 200 cannot dynamically adjust the image quality parameters. When the terminal device 300 detects that the resolution of the video stream has changed, it can notify the display apparatus 200 of the updated resolution in the form of SPS′, or can use other notification forms, such as resolution change indication information. The embodiments of the present application can enable the display apparatus to follow the changes in the resolution of the screen-mirroring cast data and synchronously and dynamically adjust the image quality parameters, so that the screen-mirroring image quality is no longer limited to the system default image quality parameters, thereby improving the display effect of the screen-mirroring content.

In some embodiments, for other non-mirror screen cast, since the terminal device 300 cannot need to record the screen, when the media data of the screen-mirroring screen remain unchanged, the resolution of the screen-mirroring screen data generally remains unchanged. Taking application screen-mirroring as an example, after the user starts the video application Q, movie M can be played. The current playback clarity of movie M is high-definition (for example, the resolution is 480 P, 720*480). The user can also click the screen-mirroring button on the playback interface of movie M, and choose to project movie M to the display apparatus 200 for playback. After the terminal device 300 establishes a screen-mirroring cast connection with the display apparatus 200, it can send the URL1 of the 480 P source of movie M to the display apparatus 200. The display apparatus 200 can receive URL1, obtain the resolution and screen direction (horizontal) corresponding to URL1, automatically match the target image quality parameter 3 according to the aforementioned scheme, and download and start playing the film source 1 of the movie M corresponding to URL1 based on the target image quality parameter 3 and URL1. Since the resolution (480 P) corresponding to URL1 is fixed, the display apparatus 200 can adjusts the image quality parameters only once when starting to play the film source 1, and cannot dynamically adjust the image quality parameters during the subsequent playback of the film source 1.

In some embodiments, the user can switch the playback definition of movie M on the terminal device 300, such as switching from high definition to ultra-high definition (for example, resolution of 720 P, 1280*720). After the terminal device 300 receives the user's operation to switch the definition, it can send the URL2 of the 720 P source of movie M to the display apparatus 200. The display apparatus 200 can receive URL2, obtain the resolution and screen direction corresponding to URL2, match the target image quality parameter 4, and adjust the image quality effect of the movie M being played according to the target image quality parameter 4.

In some embodiments, after receiving URL2, the display apparatus 200 can still maintain the playback process of the film source 1 corresponding to URL1, only match the target image quality parameter 4 according to URL2, and update the image quality parameter from target image quality parameter 3 to target image quality parameter 4.

In some embodiments, after receiving URL2, the display apparatus 200 can also close playing the film source 1 corresponding to URL1 and record the current playing progress of the film source 1. The display apparatus 200 can download and start playing the film source 2 of the movie M corresponding to URL2 according to the target image quality parameter 4 and URL2, and automatically adjust the film source 2 to the playback progress of the film source 1 when starting to play. Since the resolution (720 P) corresponding to the film source 2 is fixed, the display apparatus 200 can adjust the image quality parameters only once when the film source 2 is started, and the image quality parameters are no longer dynamically adjusted during the subsequent playback of the film source 2.

In some embodiments, before starting the screen-mirroring cast service, the display apparatus 200 can save the image mode and image quality parameters before screen-mirroring (hereinafter referred to as: the first image mode and the first image quality parameters). After controlling the display to close the second screen-mirroring interface 82, the display apparatus 200 can control the display to display the interface before screen-mirroring according to the first image mode and the first image quality parameters. In this way, the embodiments of the present application can realize: during the screen-mirroring cast process, the display apparatus 200 can dynamically and adaptively match and adjust the image quality parameters according to the local CPU configuration and the resolution of the screen-mirroring cast data, and automatically restore the image quality before screen-mirroring (image quality restoration) when exiting the screen-mirroring, thereby avoiding affecting the display effects of other source scenes.

In some embodiments, the display apparatus 200 can support multiple types of sources, including but not limited to: ATV, DTV, HDMI, local preset applications, third-party applications, etc. When connecting to physical signal sources such as ATV, DTV, and HDMI, the image quality parameters used to play the video can be preset by the source. When such a source is currently active, the image quality parameters cannot be changed at will. For example, the display apparatus 200 is playing DTV according to the image quality parameter X. At this time, it can receive a mirror screen-mirroring request initiated by the terminal device 300, and start displaying the screen-mirroring cast data with the image quality parameter Y. During this period, it is detected that the resolution of the screen-mirroring cast data has changed and is adjusted to the image quality parameter Z. Before the normal end of this screen-mirroring, the display apparatus 200 can suddenly receive a close instruction or a restart instruction, and control the display apparatus 200 to shut down. After the display apparatus 200 is started again, since the image quality restoration operation is not performed, the current effective image quality parameter of the display apparatus 200 is the image quality parameter Z before the previous shutdown. In this way, if the display apparatus 200 receives an operation to switch to DTV, when starting DTV, it can need to change from the image quality parameter Z back to the DTV default image quality parameter X, and when it is presented on the display interface, the user can view the display suddenly flicker. The user does not know that it is caused by adjusting the image quality, and can think that the display apparatus 200 has a malfunction, affecting the user experience.

In view of this, in embodiments of the present application, sources can be classified, for example, into first-category sources and second-category sources. Among them, the first type of source can support dynamic adjustment of image quality parameters. The first type of source can include but not limited to: preset sources such as pre-installed applications and third-party applications in the system, customized sources, etc. The second type of source can be a signal source whose image quality parameters cannot be adjusted dynamically (non-preset source). This type of source often has image quality parameters configured by default. The second type of source can include but not limited to: DTV, ATV, HDMI and other physical signal sources. In this way, after receiving the screen-mirroring request, the display apparatus can decide the control logic of the image quality parameters according to the type of the current source.

In some embodiments, the application layer of the display apparatus 200 can set a first state bit, and the first state bit can be used to store a first image quality parameter used by the source before the screen-mirroring cast data starts. The first state bit, for example, can record the first image quality parameters such as “brightness|contrast|chroma|clarity| . . . ” in a String type. At the end of each screen-mirroring, the display apparatus 200 can control the display to restore to the image quality before screen-mirroring according to the first image quality parameter. After the image quality restoration is completed, the first image quality parameter stored in the first state bit can be cleared, and the first state bit can be set to the first target value. The first target value can be used to indicate that the image quality restoration has been completed after the screen-mirroring is completed.

In some embodiments, the application layer of the display apparatus 200 can further set a second state bit, and the second state bit can be used to store the first image mode used by the source before the screen-mirroring cast data starts playing. The second state bit can record the identifier of the first image mode, for example, in an int type. At the end of each screen-mirroring, the display apparatus 200 can further control the display to restore to the image mode before screen-mirroring according to the first image mode. After the image mode restoration is completed, the identifier of the first image mode stored in the second state bit can be cleared, and the second state bit can be set to a second target value, and the second target value can be used to indicate that the image mode restoration has been completed after the screen-mirroring is completed. The image mode categories can include, but not limited to, standard, vivid, natural, automatic, eye protection and other modes. The first target value and the second target value can be the same or different. For example, both the first target value and the second target value can be set to −1. The embodiments of the present application do not limit the values of the first target value and the second target value.

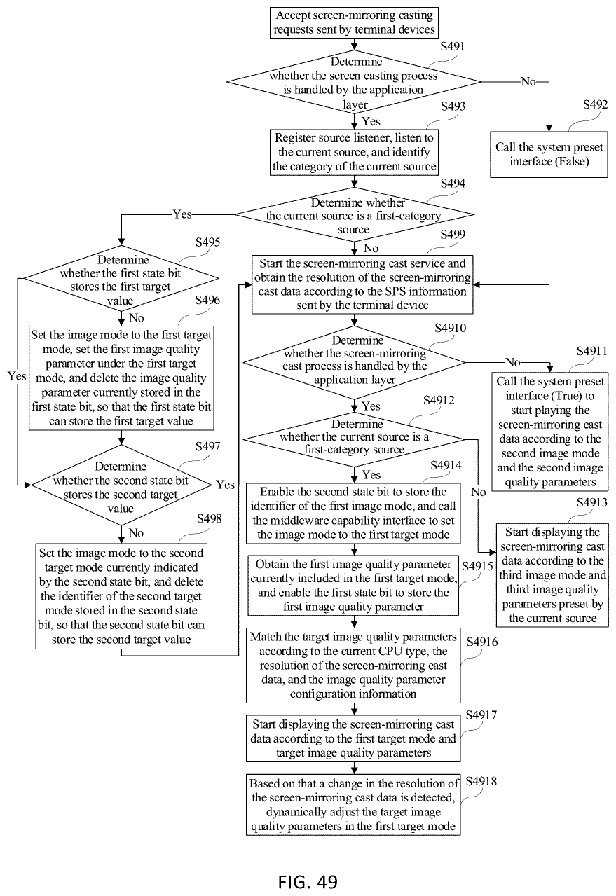

FIG. 49 is a first flowchart of a fourth processing method for a display apparatus according to some embodiments of the present application, which can be executed by at least one processor 250 in the display apparatus 200. As shown in FIG. 49, after the display apparatus 200 receives the screen-mirroring request sent by the terminal device 300, the method can include the following operations.

S491: determine whether the screen-mirroring cast process is handled by the application layer.

The embodiments of the present application provide two screen-mirroring cast processing methods: the first is to call the system preset interface to enable the system bottom layer to execute the screen-mirroring cast process; the second is to execute the screen-mirroring cast process by the application layer, and the screen-mirroring cast process can include the above-mentioned processing logic of dynamically adaptively adjusting the image quality parameters. The display apparatus 200 can store platform capability information, which can be used to indicate what kind of screen-mirroring cast processing logic the display apparatus executes.

In the specific implementation, when executing step S491, the platform capability information is obtained; if the platform capability information records a first capability value, it is determined that the screen-mirroring cast process is processed by the system bottom layer, and step S492 is executed; if the platform capability information records a second capability value, it is determined that the screen-mirroring cast process is processed by the application layer, and step S493 is executed.

S492: call the system preset interface. In step S492, the state value of the system preset interface can be False, indicating that the screen-mirroring cast service has not yet been started. Step S499 is executed after step S492.

S493: register source listener, listen to the current source, and identify the category of the current source.

S494: determine whether the current source is a first-category source. If the current source is a first type source, execute step S495; if the current source is a second type source, execute step S499.

S495, determine whether the first state bit stores the first target value.

If the first state bit does not store the first target value, it indicates that the image quality restoration was not completed when the previous screen-mirroring ended. At this time, the first state bit can store the image quality parameters recorded before the start of the previous screen-mirroring, then execute step S496; if the first state bit stores the first target value, it indicates that the image quality restoration was completed when the previous screen-mirroring ended, then execute step S497.

S496: set the image mode to the first target mode, set the first image quality parameter under the first target mode, and delete the image quality parameter currently stored in the first state bit, so that the first state bit can store the first target value. Among them, the first target mode can be the image mode set when the screen-mirroring is initialized. The first target mode can select the standard image mode, so that the screen-mirroring image quality parameters are dynamically adjusted only in the standard image mode, and the screen-mirroring image quality parameters are not adjusted in other image modes, which can reduce the impact on the image display of the display apparatus.

S497: determine whether the second state bit stores the second target value.

If the second state bit does not store the second target value, indicating that the image mode restoration was not completed when the previous screen-mirroring ended, then execute step S498; if the second state bit stores the second target value, indicating that the image mode restoration was completed when the previous screen-mirroring ended, then execute step S499.

S498: set the image mode to the second target mode currently indicated by the second state bit, and delete the identifier of the second target mode stored in the second state bit, so that the second state bit can store the second target value. Through the above process, the initialization settings of the image mode and image quality parameters before starting the screen-mirroring cast service are completed. When the application layer detects thin the first state bit stores the first target value and the second state bit stores the second target value, the screen-mirroring cast service can be started.

S499: start the screen-mirroring cast service and obtain the resolution of the screen-mirroring cast data according to the SPS information sent by the terminal device.

S4910: determine whether the screen-mirroring cast process is handled by the application layer.

In the specific implementation, when executing step S4910, the platform capability information can be obtained; if the platform capability information records a first capability value, it is determined that the screen-mirroring cast process can be processed by the system bottom layer, and step S4911 is executed; if the platform capability information records a second capability value, it is determined that the screen-mirroring cast process can be processed by the application layer, and step S4912 is executed.

S4911: call the system preset interface to start playing the screen-mirroring cast data according to the second image mode and the second image quality parameters.

Among them, the second image mode can be the image mode used by default when the system bottom layer executes the screen-mirroring cast process, and the second image quality parameter can be the image quality parameter used by default when the system bottom layer executes the screen-mirroring cast process. In step S4911, the state value of the system preset interface is True, indicating that the screen-mirroring cast service has been started.

S4912: determine whether the current source is a first-category source. If the current source is a second-category source, execute step S4913; if the current source is a first-category source, execute step S4914.

S4913: start displaying the screen-mirroring cast data according to the third image mode and third image quality parameters preset by the current source. If the current source is a second-category source, since the second-category source is a non-preset source that does not support dynamic adjustment of image quality parameters, but has a preset, default image mode (referred to as: the third image mode), and the third image mode can include preset image quality parameters (referred to as: the third image quality parameters), the screen can be projected and played according to the third image mode and the third image quality parameters.

S4914: enable the second state bit to store the identifier of the first image mode, and call the middleware capability interface to set the image mode to the first target mode.

Among them, the first image mode is the image mode set by the current source before the screen-mirroring cast data starts. The first image mode can be any one of: the first target mode, the second target mode, or the third target mode switched by the user before the screen-mirroring cast data starts.

S4915: obtain the first image quality parameter currently included in the first target mode, and enable the first state bit to store the first image quality parameter. At this time, the display apparatus 200 can display the user interface in the first target mode and with the first image quality parameter.

By executing steps S4914 and S4915, before starting screen-mirroring, the first image mode and the first image quality parameters used by the current first-category source are saved. In this way, when the display apparatus 200 ends screen-mirroring, the image quality parameters can be restored to the first image quality parameters before screen-mirroring in the first target mode (for example, the standard image mode), and the image mode can be restored to the first image mode before screen-mirroring, thereby completing image mode restoration and image quality restoration.

S4916: match the target image quality parameters according to the current CPU type, the resolution of the screen-mirroring cast data, and the image quality parameter configuration information.

S4917: start displaying the screen-mirroring cast data according to the first target mode and target image quality parameters.

S4918: based on that a change in the resolution of the screen-mirroring cast data is detected, dynamically adjust the target image quality parameters in the first target mode.

In the above method flow, the reason for repeatedly judging whether the current source is a first-category source is that: the premise for allowing dynamic adjustment of image quality parameters during screen-mirroring is that the current source is a first-category source (including designated sources such as screen-mirroring cast applications). However, on the display apparatus 200 side, the user can switch sources through the control device 100 or voice. For example, the user can click the DTV button on the remote controller to quickly play digital TV programs. When the second-category source is running, it does not support the application layer to execute the aforementioned image quality adjustment logic. Therefore, before adjusting the image quality parameters or performing image quality restoration, the application layer needs to judge the category of the current source based on the source listener, so as to ensure the accuracy of the source playback control and the image quality effect.

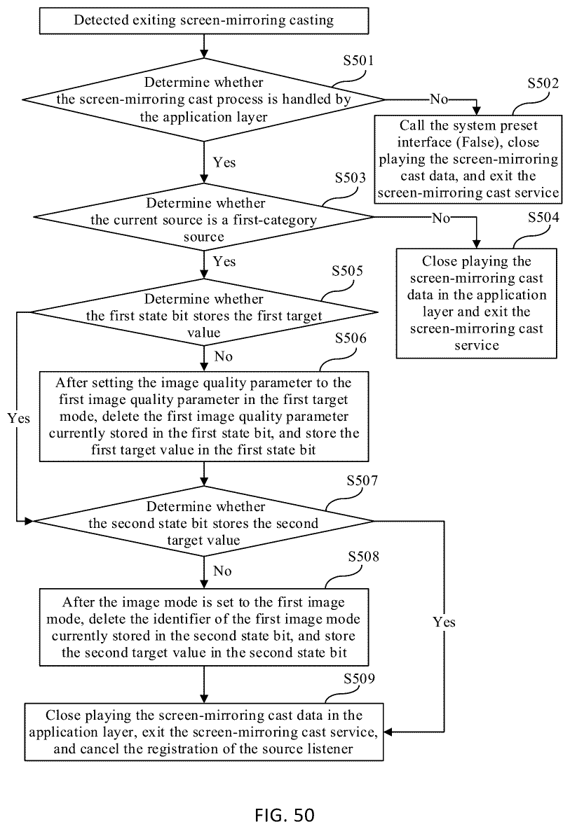

FIG. 50 is a second flowchart of a fourth processing method for a display apparatus according to some embodiments of the present application, which is executed by at least one processor 250 in the display apparatus 200. As shown in FIG. 50, based on the method flow illustrated in FIG. 49, when the display apparatus 200 detects exiting screen-mirroring, the method can include the following operations.

S501: determine whether the screen-mirroring cast process is handled by the application layer.

When any of the following conditions is met, it is detected that the screen-mirroring needs to be exited: the display apparatus 200 can receive the first screen-mirroring end information sent by the terminal device 300, or the display apparatus 200 can detect that the screen-mirroring cast connection with the terminal device 300 is disconnected, or the display apparatus 200 can receive the user's input based on the second screen-mirroring interface 82, clicking the second screen-mirroring end button 822, etc.

In the specific implementation, when executing step S501, the platform capability information can be obtained; if the platform capability information records a first capability value, it is determined that the screen-mirroring cast process can be processed by the system bottom layer, and step S502 is executed; if the platform capability information records a second capability value, it is determined that the screen-mirroring cast process can be processed by the application layer, and step S503 is executed.

S502: call the system preset interface, close playing the screen-mirroring cast data, and exit the screen-mirroring cast service. In step S502, since the program for exiting screen-mirroring is executed, the state value of the system default interface is changed to False.

S503: determine whether the current source is a first-category source. If the current source is a second-category source, execute step S504; if the current source is a first-category source, execute step S505.

S504: close playing the screen-mirroring cast data in the application layer and exit the screen-mirroring cast service.

S505: determine whether the first state bit stores the first target value.

If the first state bit does not store the first target value, indicating that the image quality restoration has not been completed, then execute step S506; if the first state bit stores the first target value, indicating that the image quality restoration has been completed at the end of this screen-mirroring, then execute step S507.

S506: after setting the image quality parameter to the first image quality parameter in the first target mode, delete the first image quality parameter currently stored in the first state bit, and store the first target value in the first state bit. When executing step S506, if the currently effective image mode is not the first target mode, the image mode can be set to the first target mode, and then the image quality parameters can be restored in the first target mode.

S507: determine whether the second state bit stores the second target value.

If the second state bit does not store the second target value, indicating that the image mode restoration is not completed, then execute step S508; if the second state bit stores the second target value, indicating that the image mode restoration is completed at the end of this screen-mirroring, then execute step S509.

S508: after the image mode is set to the first image mode, delete the identifier of the first image mode currently stored in the second state bit, and store the second target value in the second state bit.

In the first target mode, the image quality parameters are restored to the first image quality parameters used before the screen-mirroring starts, and then the image mode is restored from the first target mode to the first image mode used before the screen-mirroring starts. In this way, when the screen-mirroring ends, the display presents the user interface according to the first image mode and the image quality parameters contained in the first image mode.

S509: close playing the screen-mirroring cast data in the application layer, exit the screen-mirroring cast service, and cancel the registration of the source listener.

In some embodiments, during the screen-mirroring cast process, the source listener can listen to events of source switching, such as the current source changing to the target source. If the application layer determines that the target source is a second-category source, it will not restore to the first image quality parameters before screen-mirroring when switching the source, that is, it will not execute the image quality restoration program. The target source can be started according to the default third image mode and third image quality parameters preset by the target source, thereby avoiding abnormalities when the target source starts. The abnormality can be presented as a flickering of the target source screen or a sudden change in image quality. When returning to the screen-mirroring interface from the target source, or restarting the screen-mirroring, steps S491 to S4918 can be referred to perform initialization settings before starting the screen-mirroring, and then according to steps S499 to S4918, execute the start of the screen-mirroring cast data and the dynamic adjustment of the image quality parameters during the screen-mirroring.

If the application layer determines that the target source is a first-category source, for example, switching from a screen-mirroring cast application to Launcher (desktop, or home-interface), then when switching the source, steps S505 to S509 can be referred to restore to the first image mode and first image quality parameters before screen-mirroring, thereby restoring the image mode and image quality.

The embodiments of the present application can match the image quality parameters suitable for screen-mirroring according to the CPU chip type, the resolution of the screen-mirroring cast data and the image quality parameter configuration information preset in the display apparatus, and can dynamically adjust the image quality parameters synchronously with the changes in the resolution of the screen-mirroring cast data, thereby improving the image quality and clarity of the screen-mirroring, thereby providing users with a better screen-mirroring experience. The display apparatus can listen to the source switching events, and by identifying the platform processing capabilities (the execution subject is the application layer or the system bottom layer) and the category of the current source (first-category source or second-class source), it provides the corresponding screen-mirroring cast process and image quality processing logic to ensure the accuracy of source playback control and image quality. When the display apparatus switches sources or exits screen-mirroring, it can decide whether to perform image mode and image quality restoration based on the current source category and platform processing capabilities to avoid affecting the display effects of other source scenes. The embodiments of the present application improve the screen-mirroring performance and image display effect of the display apparatus.

In addition, the UI drawings shown in the embodiments of the present application are merely schematic. Based on the aforementioned processing logic for dynamically adjusting the screen-mirroring image quality, the field can expand and adjust the screen-mirroring cast process and screen-mirroring image quality adjustment scheme according to different screen-mirroring types, screen-mirroring protocols, user operations, and source types, so as to adapt to more possible scenario requirements.

In some embodiments, the present application can further provide a computer readable non-volatile storage medium, which may store a computer program. When the computer readable non-volatile storage medium is configured in the display apparatus 200, the computer program can be executed by at least one processor to implement the various processes of any method in the above embodiments and can achieve the same technical effect. To avoid repetition, it will not be repeated here. The computer readable non-volatile storage medium can be a magnetic disk, an optical disk, a ROM or a RAM, etc.

What is claimed is:

1. A display apparatus, comprising:
a display, configured to display a user interface and/or screen-mirroring cast data;
a communicating device, configured to communicate with an external device and/or form a screen-mirroring cast connection with a terminal device according to a communication protocol;
a memory, configured to store computer instructions and/or data associated with the display apparatus;
at least one processor, in connection with the display, the communicating device and the memory, wherein the at least one processor is configured to execute the computer instructions to cause the display apparatus to perform:
in response to a screen-mirroring cast instruction, obtaining a preparation state of a first application and starting a second application; wherein the first application is an application displayed in a current user interface, and the second application is a screen-mirroring cast application; the preparation state is used to indicate whether the first application supports floating display;
based on that the preparation state is a state that supports floating, controlling the display to display the second application above the first application in a floating manner;
based on that the preparation state is a state that does not support floating, controlling the display to display the second application in a full-screen manner.

2. The display apparatus according to claim 1, wherein the at least one processor is further configured to execute the computer instructions to cause the display apparatus to perform:
traversing all applications in the display apparatus;
selecting the second application that supports a floating function from the all applications;
bonding a client service in the first application and a client service in the second application to establish a data intercommunication relationship between the first application and the second application.

3. The display apparatus according to claim 1, wherein the at least one processor is further configured to execute the computer instructions to cause the display apparatus to perform:
before the second application is displayed above the first application in the floating manner, controlling the display to display an operation prompt interface above the first application;
after the second application is displayed above the first application in the floating manner, generating a floating receipt, and sending the floating receipt to the first application;
exiting the operation prompt interface according to the floating receipt.

4. The display apparatus according to claim 1, wherein for floating the second application above the first application, and the at least one processor is further configured to execute the computer instructions to cause the display apparatus to perform:
controlling the display to display the first application in the full-screen manner;
setting a theme of the second application to be transparent;
controlling the display to overlay and display the second application with a transparent theme above the first application.

5. The display apparatus according to claim 1, wherein the at least one processor is further configured to execute the computer instructions to cause the display apparatus to perform:
controlling the second application to capture a focus instruction in the user interface;
sending the focus instruction to the first application;
parsing the focus instruction;
sending a parsing result of the focus instruction to another application, so that the another application operates according to the parsing result, wherein the another application is an application other than the first application and the second application in the display apparatus.

6. The display apparatus according to claim 1, wherein the at least one processor is further configured to execute the computer instructions to cause the display apparatus to perform:
in response to a screen-mirroring cast disconnection event, generating a disconnection instruction;
sending the disconnection instruction to the first application;
controlling the display to exit the second application according to the disconnection instruction.

7. The display apparatus according to claim 6, wherein the at least one processor is further configured to execute the computer instructions to cause the display apparatus to perform:
parsing a disconnection reason of the disconnection instruction from the disconnection instruction;
generating a prompt message according to the disconnection instruction and the disconnection reason;
controlling the display to display the prompt message based on that exiting the second application.

8. The display apparatus according to claim 1, wherein the at least one processor is further configured to execute the computer instructions to cause the display apparatus to perform:
detecting a running state of the first application;
based on that the running state is abnormal, detecting a screen-mirroring cast state of the second application;
based on that the second application is in the screen-mirroring cast state, exiting the second application;
based on that the second application is in a non-screen-mirroring cast state, controlling the display to display the second application in the full-screen manner.

9. The display apparatus according to claim 1, wherein the at least one processor is further configured to execute the computer instructions to cause the display apparatus to perform:
in response to a screen switching instruction for playing media data in the second application, obtaining a playing window size of the second application;
modifying the playing window size according to the screen switching instruction;
playing the media data in the second application according to a modified playing window size.

10. The display apparatus according to claim 1, wherein the display is further configured to display a user interface of the first application and to display a user interface of the second application above the first application;
the at least one processor is further configured to execute the computer instructions to cause the display apparatus to perform:
receiving a switching instruction for switching a display position of an application;
in response to the switching instruction, switching levels of the first application and the second application to control the display to display the user interface of the second application in the full-screen manner; wherein the first application and the second application are applications that establish a data intercommunication relationship with each other and both support floating display;
reading an image size of the first application, and setting a floating window above the second application according to the image size;
controlling the display to display the user interface of the first application in the floating window.

11. The display apparatus according to claim 10, wherein the at least one processor is further configured to execute the computer instructions to cause the display apparatus to perform:
receiving a startup instruction for displaying an application image;
in response to the startup instruction, obtaining the preparation state of the first application, and starting the second application;
based on that the preparation state of the first application is a state of preparation completion, controlling the display to display the second application above the first application in the floating manner;
based on that the preparation state of the first application is an unprepared state, controlling the display to display the second application in the full-screen manner.

12. The display apparatus according to claim 10, wherein the at least one processor is further configured to execute the computer instructions to cause the display apparatus to perform:
monitoring a focus event of the first application;
encapsulating an event for switching a display position as the switching instruction;
controlling the first application to execute the switching instruction, and sending the switching instruction to the second application, so that the second application executes the switching instruction.

13. The display apparatus according to claim 12, wherein the at least one processor is further configured to execute the computer instructions to cause the display apparatus to perform:
after switching the levels of the first application and the second application, detecting a level position of the first application;
marking a window of the first application as a target window according to the level position;
monitoring a focus event of the target window, and encapsulating the focus event as a control instruction corresponding to the focus event.

14. The display apparatus according to claim 10, wherein the at least one processor is further configured to execute the computer instructions to cause the display apparatus to perform:
obtaining media data of a target application, wherein the target application is the first application or the second application;
parsing an image size in the media data to obtain an image state of the target application image, wherein the image state comprises a horizontal state and a vertical state;
based on that the image state of the target application image changes, generating a screen rotation instruction for the horizontal state or the vertical state, so that the target application executes the rotation instruction.

15. The display apparatus according to claim 14, wherein the at least one processor is configured to execute the computer instructions to cause the display apparatus to perform:
based on that the image state of the target application image changes, obtaining a window size of the target application;
based on that a window width of the target application is greater than or equal to a window height, obtaining the window height, and setting a floating window above the second application according to the window height and the image size;
based on that the window width of the target application is smaller than the window height, obtaining the window width, and setting a floating window above the second application according to the window width and the image size.

16. The display apparatus according to claim 10, wherein the at least one processor is configured to execute the computer instructions to cause the display apparatus to perform:
receiving a close instruction;
sending the close instruction to the first application;
executing the close instruction by the first application, and/or controlling the first application to forward the close instruction to the second application to control the second application to execute the close instruction.

17. The display apparatus according to claim 16, wherein the at least one processor is configured to execute the computer instructions to cause the display apparatus to perform:
detecting a close state of the first application and the second application;
based on that the second application is in the close state and the first application is in a start state, controlling the display to display the user interface of the first application in the full-screen manner.

18. The display apparatus according to claim 1, further comprising:
a rotating component, configured to rotate the display;
wherein the display is further configured to display a user interface of the first application, and to display a user interface of the second application in a floating window above the first application;
the at least one processor is further configured to execute the computer instructions to cause the display apparatus to perform:
in response to a rotation event of the rotating component, converting a display screen direction of the first application, and obtaining a window size and an image size of the second application; wherein the first application and the second application are applications that establish a data intercommunication relationship with each other and both support floating display;
generating layout information according to a converted display screen direction of the first application and the window size of the first application;
setting a floating window above the first application according to the layout information and the image size, and controlling the display to display the user interface of the second application in the floating window.

19. The display apparatus according to claim 18, wherein the at least one processor is configured to execute the computer instructions to cause the display apparatus to perform:
monitoring a rotation direction of the rotating component, and changing a global screen direction according to the rotation direction, wherein the global screen direction is a display screen direction of the display;
in response to a startup instruction for displaying an image of the first application, obtaining the global screen direction;
controlling the display to display the user interface of the first application in the full-screen manner according to the global screen direction.

20. The display apparatus according to claim 19, wherein the at least one processor is configured to execute the computer instructions to cause the display apparatus to perform:
in response to a startup instruction for displaying an image of the second application, obtaining the image size of the second application and the global screen direction;
setting the floating window above the first application according to the image size of the second application and the global screen direction;
controlling the display to display the user interface of the second application in the floating window.
